(19) United States
(12) Patent Application Publication
(10) Pub. No.: US 2021/0012278 A1
(43) Pub. Date: Jan. 14, 2021

(54) SYSTEMS AND METHODS FOR SUPPLY CHAIN MANAGEMENT AND INTEGRITY VERIFICATION VIA BLOCKCHAIN

(71) Applicant: SECURITY MATTERS LTD., D.N. Hevel Eilot (IL)

(72) Inventors: Haggai ALON, Kibbutz Naan (IL); Nadav YORAN, Tel Aviv (IL); David Mark ROSENBLATT, Tenafly, NJ (US)

(21) Appl. No.: 16/980,693

(22) PCT Filed: Mar. 14, 2019
(86) PCT No.: PCT/IL2019/050283

§ 371 Date: Sep. 14, 2020

Related U.S. Application Data
(60) Provisional application No. 62/642,858, filed on Mar. 14, 2018.

(51) Int. Cl. G06Q 10/08; G06F 16/182; G06Q 20/36; H04L 9/06; G06K 19/06

(52) U.S. Cl. CPC G06Q 10/0833; G06F 16/1837; G06Q 10/0832; H04L 2209/38; G06Q 20/3678; H04L 9/0618; G06K 19/0614; G06Q 10/087

(57) ABSTRACT

Systems and methods for managing transactions of physical objects are disclosed. The system is connectable to a first distributed ledger adapted to record object transactions associated with transactions of one or more physical objects between parties. The system includes a second distributed ledger adapted to record data indicative of object handling operations carried out with respect to the one or more physical objects; and an object handling management module adapted to authenticate handling operations carried out with respect to the one or more physical objects. The object handling management module is configured and operable for obtaining parameters of execution of the handling operations, authenticating the parameters of execution of the handling operations, and recording the authenticated handling operations in the second distributed ledger. The system thereby enables recordation of the object transactions associated with the one or more physical objects upon authenticating that the parameters of execution of the handling operations that are carried out with respect to the one or more physical objects satisfy one or more respective predetermined conditions.

### TECHNOLOGICAL FIELD

The present invention is in the field of supply chain management and more specifically relates to management of supply chains over distributed ledgers.

### BACKGROUND

X-Ray fluorescence signature and/or marking (referred to generally herein as markings) of objects facilitate a robust and reliable technique for marking and authenticating various physical objects, and/or the types or batches/lots of such physical objects, while preventing/eliminating counterfeiting of such physical objects with practical measures (e.g. without destruction of the physical object). Techniques for marking, and/or authenticating various types or objects based on XRF markings/signatures added to the objects and/or originally inherently existing in the objects, are versatile robust and may be used for identification and authentication of various types of objects and materials.

For example, PCT patent application publication WO 2016/157185 co-assigned to the assignee of the present Application discloses a method and a system for authenticating an object marked with XRF marking The method includes providing a wavelength spectral profile of a detected portion of an X-Ray signal arriving from an object in response to X-Ray or Gamma-Ray radiation applied to the object and filtering the wavelength spectral profile of a detected portion of an X-Ray signal to suppress trend and periodic components from the wavelength spectral profile, which are associated with at least one of noise and clutter in the X-Ray signal portion, thereby obtaining a filtered profile with improved signal to noise and/or signal to clutter ratio from which spectral peaks associated with signatures of materials included in said object can be identified with improved accuracy and reliability. The object is authenticated by processing the filtered profile to identify one or more peaks therein, which satisfy a predetermined condition, whereby the wavelengths of the identified peaks are indicative of the signatures of materials included in the object.

PCT patent application publication WO 2017/134660 co-assigned to the assignee of the present Application discloses an anti-counterfeit marking technique for verifying authenticity of objects, such as metallic objects, using x-ray fluorescence (XRF) analysis.

PCT patent application publication WO 2017/175219 co-assigned to the assignee of the present Application discloses methods and systems for verifying compatibility of components (e.g. parts or devices) of an electronic system. In certain embodiments the method includes: irradiating a first and second components presumably associated with the electronic system, with XRF exciting radiation, and detecting one or more XRF response signals indicative of a first and a second XRF signatures, emitted from the first and second components in response to the irradiation. Then the first and second XRF signatures are processed to determine whether they are associated with respectively a first and second XRF marking compositions on the first and second components, and the compatibility of the first and second components to the electronic system is determined/verified based on the correspondence between the first and a second XRF signatures/marking Certain embodiments also disclose electronic systems including at least a first and a second electronic components/devices respectively having the first and second XRF marking compositions that enable verification of compatibility of the components. Certain embodiments disclose techniques for pairing the first and second components (e.g. devices) based a correspondence between the first and second XRF signatures/markings thereof. Certain embodiments disclose various calibration techniques for calibrating the XRF measurements of XRF markings applied to different substrate materials of the electronic components.

PCT patent application publication WO 2018/055625 co-assigned to the assignee of the present Application discloses a method for detecting mishandling and misuse of food products, and provides a method for marking a product for human or animal use with an XRF identifiable mark. The method includes forming on at least a region of the product a pattern of at least one FDA-grade material identifiable by XRF, the pattern being optionally at least partially invisible to the naked human eye and having a predefined identifiable characteristic, wherein the product is selected from food products, therapeutics and cosmetics.

PCT patent application publication WO 2018/042427 co-assigned to the assignee of the present Application discloses methods and systems for authentication of precious stones, according to their natural ID and/or predetermined markings created in the stones, based on unique characteristic radiation response of the stone to predetermined primary radiation.

PCT patent application publication WO 2018/069917 co-assigned to the assignee of the present Application discloses formulations and masterbatches of a polymeric material and XRF-identifiable markers, for producing transparent elements comprising a polymer and at least one XRF-identifiable marker for a variety of industrial uses.

Various techniques for implementing accurate and reliable readings of XRF markings (e.g. signatures) of physical objects include for instance the technique described in WO 2016/157185 indicated above. The XRF readers for that matter may be implemented for example as described in PCT patent application publication WO 2017/221246 co-assigned to the assignee of the present Application disclosing a novel XRF analyzer capable of simultaneously identifying the presence of a marking composition in a plurality of objects by modulating/varying the intensity of the excitation beam on the different objects and measuring the secondary radiation thereof. The XRF analyzer comprises a radiation emitter assembly adapted for emitting at least one X-Ray or Gamma-Ray excitation radiation beam having a spatial intensity distribution for simultaneously irradiating the plurality of objects; a radiation detector for detecting secondary radiation X-Ray signals arriving from a plurality of objects in response to irradiation of the objects by X-Ray or Gamma-Ray radiation, and providing data indicative of spatial intensity distribution of the detected data X-Ray signals on the plurality of objects; and a signal reading processor in communication with the detector, the processor being adapted for receiving and processing the detected response X-Ray signals to verify presence of the marking composition included at least one surface of each object of the plurality objects. Also PCT patent application publication WO 2018/051353 co-assigned to the assignee of the present Application discloses a control system and method for controlling operation of an X-ray Fluorescent (XRF) system for detecting at least one material carried by a sample, for example at least one marker carried by the sample. The control system comprises: data input utility for receiving input data comprising material/marker related data about said at least one material/marker; and data processor and analyzer utility. The data processor and analyzer utility is configured and operable for analyzing the input data and determining optimal geometrical characteristics of the XRF system for optimizing operational conditions of said XRF system to maximize amount of primary X-ray radiation that reaches a predetermined region of the sample and is absorbed by a volume of said region and to maximize a portion of secondary radiation emitted from said region that reaches a detector of the XRF system; and for generating operational data to the XRF system enabling adjustment of the geometrical characteristics of the XRF system.

In the virtual domain, blockchain technology provides a robust and secure way to store/register data records in distributed manner while practically eliminating possibilities of counterfeit or otherwise un-permission change the data. Blockchain technology is based on a network of nodes each maintaining a copy of a ledger of records organized in an ever-growing time-sequenced blocks of data. Typically, blockchain-type data records provide a registry (e.g. public) utilizing a distributed computing system and configured to achieve data security from hacking and unwanted changes. The architecture and design of the blockchain ensure that a digital data record cannot be corrupted or duplicated (i.e. cannot be spent more than once) and can therefore be used as a virtual asset. Data recorded in the blockchain often refers to the chain of ownership of such virtual assets known as cryptocurrencies or tokens (also referred to as virtual currencies).

For example PCT patent application publication WO 2018/064645 discloses a distributed manufacturing platform and related techniques connect designers, manufacturers (e.g., 3D printer owners and other traditional manufacturers), shippers, and other entities and simplifies the process of manufacturing and supplying new and existing products. A distributed ledger or blockchain may be used to record transactions, execute smart contracts, and perform other operations to increase transparency and integrity of supply chain. Blockchain enabled packaging can be used to track movement and conditions of packages from manufacture, through transit, to delivery.

U.S. patent application publication 2019/012861 discuses a supply chain system including a server that manages at least a right of ownership of an article. The article is an actual object. A container is provided with a lock. The lock is configured to at least open through an electronic process. The container is capable of physically storing the article. At least one of a processor or a circuit, when an opening request to open the lock is received, determines whether a user who has issued the opening request and a user who has the right of ownership of the article match. When the user who has issued the opening request and the user who has the right of ownership of the article match, the lock is opened for allowing the article to be removed from the container. The server is notified that the lock has been opened.

### General Description

Various type of objects can be readily identified or characterized based on inherent and/or added/embedded XRF markings/signatures thereof. These objects may include for example: metallic objects, polymers, food products, precious stones, electronic components/systems, as well as various other objects/materials. As can be appreciated from the above described techniques, the addition, or characterization of inherent, XRF marking/signature to an object may be achieved with readily simple processing and in cost effecting manner (e.g. by embedding and/or characterizing XRF responsive materials in/on the object).

The present invention provides a novel approach of linking the robustness and security of blockchain technology for registering transactions in the virtual domain, with the robustness, anti-counterfeiting security and versatility of XRF technologies marking/characterizing XRF markings/signatures of various types of objects and identifying the various objects, and/or their types/lots based on such XRF markings

Indeed, the technique of the present invention is not essentially limited to XRF type of marking/signatures of physical objects. However as will be readily appreciated by those versed the novel combination of combination identification, tracking and authentication of handling operations carried out on physical objects by specifically utilizing versatile XRF markings/signatures of such objects, while the recordation of such authentication handling on a blockchain ledger according to the present invention as described below provides a robust and secure approach for managing virtual transactions of physical objects while preventing anti-counterfeiting.

To this end, the technique of the present invention may also be implemented by an integral/independent object signature reader directly linking the physical objects themselves (not a packaging/tags associated therewith) and execution conditions of handling operations performed on the physical objects, with the decentralized blockchain system(s) which may be used to track and register the handling operations of such objects in decentralize manner, e.g. without using any intervening/centralized service/server or module. Accordingly authentication of handling operations performed on prescribed physical objects and verification that the handling operations performed on the prescribed physical objects may be obtained securely without intervening third party involved.

To this end, in some embodiments, the present invention provides a blockchain and a token system facilitating peer to peer (e.g. business to business) transactions involving physical objects and/or products.

The technique of the present invention may be implemented for providing a distributed, open and secure Ecommerce platform for exchange between virtual currencies and physical objects/products. The blockchain(s) used/incorporated by the system of the present invention, or some of them, may form a decentralized, permissionless network utilizing mechanisms such as proof-of-work or proof-of-stake for achieving consensus, or a permissioned system where only authorized parties are allowed to participate as nodes in the network. In yet another option, while non-authorized parties/entities may join to the blockchain(s) as nodes, one or more parties may be privileged and have more authority than other members of the blockchain(s). For example, privileged parties may have the right to validate transaction, or the authority to add new nodes to the blockchain. As will be readily appreciated from the below description, advantageously in some cases, a system of the present invention may be implemented as privileged party of the blockchain. The system of the present invention is based, inter alia, on the ability to physically mark various types of goods, products and/or packaging, providing it with a secure and practically unforgeable physical signature. The overall architecture of the system of the present invention enables the implementation of transactions and smart contracts, (that is, protocols which, once their terms are set, are enforced or executed automatically) between two or more virtual currency accounts and involving physical objects/products. The blockchain system(s) may be implemented on network of nodes (running for example on network of servers). The blockchain system(s) are used/facilitate storage and management of information relating to the ownership and/or possession of marked tangible/physical objects (the owner of an object may be different than the party holding or in possession of the object). Members of the blockchain system(s), which do not operate node(s), may interact with the blockchain system via digital wallets or blockchain application via which they are able to read the data in the blockchain and carry out transaction (e.g. transfer ownership) with the assets recorded in blockchain. The blockchain system may be either a decentralized open permission-less system or a permissioned system where only authorized parties can become members of the blockchain network. The blockchain system may include a native cryptocurrency or token. Namely, a virtual currency which is traded and whose ownership history is recorded in the blockchain system.

The technique of the present inventions provides for implementing transactions and smart contracts involving a virtual asset and marked tangible objects (hereinafter marked object) whose ownership is recorded on the blockchain system. The operations of recording the ownership or transferring the ownership of a marked object may require a reading of the marking on the marked object by a reading unit (authenticating the object). In order to read the marking the reading unit may require reference data storage which may be performed by the system of the present invention, or decentralized storage in one or more blockchain systems. In some implementations, aspect access to the reading units used by the technique of the present invention for authenticating physical objects or entities, and/or to related reference data may require authorization/ via preselected transaction of tokens on the blockchain system (e.g. as authorization or payment) from the one or more parties to the transaction to a preselected digital wallet.

In a further aspect of the present invention the blockchain system may record both the ownership of a marked object (e.g. in a first ledger) and the party which is possession of the marked object (e.g. in another ledger). It would readily be appreciated that different ledgers may be register by the same blockchain system, e.g. by the same chain of blocks, or by different blockchain systems. The system may facilitate transaction involving change in possession of the object with or without transfer of ownership. A transaction in which the possession of the object is transferred from one party to another may require a transfer of a different amount of tokens than a transaction which includes transfer of ownership, or a transfer which include both. Additionally, requirements in terms use of readers may be different for different transactions. For example, a transaction of one type (e.g. transaction involving transfer in ownership) may require a reading of the marking on the object whereas a transaction of different types (e.g. transfer solely in possession) may not.

To this end, according to a broad aspect of the present invention there is provided a system for managing transactions of physical objects. The system is connectable to a first distributed ledger adapted to record object transactions associated with transactions of one or more physical objects between parties. The system includes a second distributed ledger adapted to record data indicative of object handling operations carried out with respect to the one or more physical objects; and an object handling management module adapted to authenticate handling operations carried out with respect to the one or more physical objects. The object handling management module is configured and operable for obtaining parameters of execution of said handling operations, authenticating the parameters of execution of the handling operations, and recording the authenticated handling operations (e.g. the authenticated parameters of execution thereof) in the second distributed ledger. The system thereby enables recordation of the object transactions associated with said one or more physical objects upon authenticating that the parameters of execution of the handling operations that are carried out with respect to the one or more physical objects satisfy one or more respective predetermined conditions.

In some embodiments the first ledger is configured and operable for recording at least one of the following transactions: (i) transactions of ownerships of the one or more objects; and (ii) transactions of tokens associated with changes of ownerships of said one or more objects.

In some embodiments the first distributed ledger is a smart contract ledger having access to the second distributed ledger and adapted to obtain said data indicative of at least one handling operation carried out with respect to a certain physical object and recording transaction of the at least one object in the first ledger upon determining that the at least one handling operation complies with at least one predetermined condition indicated by a smart contract in the smart contract ledger for transaction of said at least one object.

In some embodiments the system includes a condition verifier module, having access to the second distributed ledger and configured and operable to obtain the data indicative of at least one handling operation carried out with respect to a certain physical object, and recording transaction of the at least one object in the first ledger 10 upon determining that the at least one handling operation complies with at least one predetermined condition.

In some embodiments the system is connectable to a blockchain system configured and operable for implementing the first distributed ledger. Alternatively or additionally in some embodiments the system is connectable to the blockchain system which is configured and operable for implementing the second distributed ledger. In some embodiments the blockchain system is configured and operable for implementing both the first and second distributed ledgers. In some implementations the object handling management module includes privileged nodes of the blockchain system and is operable for recording, in the second distributed ledger, the parameters of execution of the handling operations. In this regards non-privileged nodes of the blockchain system, may not be allowed to initiate writing of data records of the second distributed ledger in the blockchain.

In some embodiments the system includes a token management module (e.g. also referred to herein as tool) connectable to the object handling management module, or to a communication module of the system, and configured and operable to enable authentication/validation of said handling operations by the object handling management module upon receipt of data indicative of at least one predetermined token transaction in a certain blockchain system.

In some embodiments the object handling management module is adapted to authenticate the handling operations, which are carried out with respect to the one or more physical objects, whereby the one or more physical objects are marked by one or more markings readable by one or more reader units (herein after also referred to interchangeably as object signature reader(s)). The object handling management module is adapted to authenticate a handling operation of a physical object by obtaining, from at least one reader unit, data indicative of a specific marking of the object, which is being read by the reader unit in relation to the handling operation. In some implementations the object handling management module is adapted to obtain data identifying the reader unit and authenticate the handling operation of the physical object by utilizing the specific marking of the object to authenticate identity of the object, utilizing the data identifying the reader unit to authenticate identity of an entity which has possession of the reader unit and which implements the handling operation, and thereby verify that the handling operation is carried out on the identified object by said entity. To this end, the object handling management module may be configured and operable for carrying out the following:
i. authenticating the identity of said object by determining a match between: data of said specific marking of the object as obtained from said reader unit, with pre-stored reference data indicative of said specific marking by the object;
ii. authenticate identity of the entity in possession of the reader unit by determining a match between the data identifying said reader unit, and reference data listing identities of said one or more reader units in association with respective entities that are in possession of said one or more reader units.

According to some embodiments the authentication of the handling operation further includes verifying that the handling operation, which is carried out on said object, is authorized for said entity.

In some embodiments the first distributed ledger is a smart contract ledger including a smart contract for transaction of the physical object. The smart contract may be indicative of predetermined conditions of execution of certain one or more respective handling operations to be carried out for the object transaction of the physical object. Validating the handling operations may include determining that the handling operations are carried out by the respective entities, which are indicated by the conditions of execution (herein after also referred to as designated entities), and comply with the conditions predetermined conditions of execution.

According to some embodiments the object handling management module is also adapted to authorize the reader unit (e.g. and/or a marking/signature reading module thereof) to read the specific marking of the object. To this end, the object handling management module may authorize the reader unit to read the specific marking, by communicating with the reader unit (e.g. with its marking/signature reading module) for providing thereto data indicative of reading parameters by which to read the specific marking In turn, the reader unit (e.g. the marking/signature reading module) is adapted to operate a certain reading scheme corresponding to the reading parameters and thereby determine and communicate the data indicative of a specific marking of the object, to the object handling management module.

In some embodiments the physical objects are marked by physical markings indicative of the physical objects and applied to, or embedded within, the physical objects. The physical markings of respective physical objects may identify the respective physical objects, and/or identify the respective types or batches of the physical objects.

In some embodiments the physical markings are X-Ray-Fluorescence (XRF) signatures identifiable via XRF analysis of the respective physical objects. The reader units (e.g. the marking/signature reading modules thereof) are configured and operable for carrying out XRF measurements to read the XRF signatures. For instance the reader units may be configured and operable to carry out the XRF measurements by illuminating at least parts of said objects with X-Rays or gamma-Rays and detecting X-Ray-Fluorescence response indicative of the XRF signatures of the physical objects. In some implementations, the reader units (e.g. the marking/signature reading modules thereof) are configured and operable to process the XRF signatures of the physical objects to determine their markings/signatures respectively. To this end, markings/signatures may be elemental markings of the physical objects associated with material composition of the objects, thus being inseparable from said objects.

According to some embodiments of the present invention the handling operations involved in object transaction of a physical object may include any one of the following:
(i) change in possession of the object;
(ii) transportation/Storage of the object;
(iii) assembly of the object with another object.

To this end, in some embodiments the system may be associated with a smart contract in said first ledger, or a handling condition registry, including at least one predetermined condition for carrying out the handling operations of the transaction of the object. The predetermined condition for a handling operation may for example include data indicative of a certain entity designated to be in possession of said object for executing the respective handling operation, and/or the identity of the object that is subject of the handling operation, and/or its type/batch. Moreover, in some cases the predetermined condition may include one or more of the following:
environmental/ambient conditions required for implementing the handling operation;
location conditions for implementing the handling operation;
identification of said another object as a pre-requisite for the handling operation.

In some embodiments the object handling management module is connectable to one or more sensory systems configured and operable for measuring execution conditions of the at least one predetermined condition, in relation to the handling operations, and accordingly communicate the parameters of execution of the handling operation to the object handling management module. For example the object handling management module may be connectable to at least one reader unit adapted for identification of the object by reading the specific marking of the object. The one or more sensory systems may be associated with (e.g. included in) the at least one reader unit and adapted to communicate the execution conditions of the handling operation in association with the parameters of execution of the respective handling operation. A sensory system may include for example at least one sensor and a readout utility for communicating parameters of execution data measured by the sensor. The at least one sensor may be for example: a temperature sensor, a humidity sensor, a light sensor, a position sensor (e.g. GPS), an inertial sensor, and a timer/timing sensor.

According to yet another broad aspect of the present invention there is provided a method for managing transactions of physical objects. The method includes carrying out the following per each handling operation of one or more handling operations, which are to be performed with respect to a physical object, for registration of an object transaction for that physical object in a first distributed ledger:
determining measured execution parameters of the handling operation, whereby determining the measured execution parameters includes reading a marking/signature of the object by a reader assigned to an entity performing the handling operation;
authenticating the measured execution parameters, to determine data indicative of the physical object, on which said handling operation is performed, based on a marking/signature read by the reader, and identify the entity performing the handling operation based on data about the reader; and
utilize the authenticated execution parameters to validate registration of the handling operation in a second distributed ledger, which thereby presents a distributed ledger of authenticated handling operations;
   The method thereby enables to validate registration of the object transaction in the first distributed ledger, upon registration of each of the one or more handling operations as authenticated handling operation in the second distributed ledger.

In some embodiments the method further includes verifying that the authenticated execution parameters of said handling operation fulfill predetermined conditions required for said object transaction and indicative of at least a designated entity for performing said handling operation, and identity or type of designated object, which is designated to be subject of said handling operation; said verifying comprises: determining a match between said object, being the actual object upon which the handling operation, and the designated object; and determining a match between said entity, being the actual entity performing the handling operation, and the designated entity.

According to some embodiments the determining of the measured execution parameters of at least one handling operation, further includes measuring additional sensory data from a sensor associated with the reader unit; and the verifying further includes determining a match between the sensory data and additional execution conditions included is the predetermined conditions. In some embodiments, validation of the registration of the handling operation in the second ledger includes the verification that the measured execution parameters of the handling operation meet the predetermined condition.

To this end, in some embodiments the validation of the registration of the object transaction in the first ledger, may include verifying of the measured execution parameters per each of the one or more handling operations associated with that object transaction.

As indicated above the first ledger may be a smart contract ledger including a smart contract for performing the object transaction. In some embodiments the smart contract includes sub-transactions, whereby one or more of the sub-transactions (e.g. which may optionally be in the form of computer executable cods/scripts, executable by the first ledger) are associated with the one or more handling operations and are adapted for accessing the second ledger and carry out the above indicated verification that the authenticated execution parameters of the one or more handling operation fulfill the predetermined conditions required for the object transaction.

As indicated above, in some embodiments the physical object has identifiable XRF signature/marking and the reading of the marking/signature includes detecting the XRF signature of the object to thereby enable determination of identity or type or batch of the object. The XRF signature/marking may be elemental to the object and associated with material composition of one or more parts of the object, thus being inseparable from said object.

According to yet another broad aspect of the present invention there is provided an object signature reader (e.g. referred to above also as reader or reader unit) which may be configured and operable for operating independently for monitoring/measuring handling operations of an object; authenticating the handling operations, and possibly verifying that the authenticating handling operations meet predetermined conditions, and registering the authenticated and possibly also verified handling operations in a second ledger. The object signature reader may be in data communication with one or more blockchain systems and may thereby enable the validation of the object transactions in the first distributed ledger implemented by the one or more blockchain systems. The object signature reader includes: (a) a signature/marking reading module configured and operable for reading a marking/signature on the physical object to determine data of indicative of the marking/signature; (b) an identifying module carrying reader ID data uniquely identifying the object signature reader; (c) a network communication module enabling data communication of the object signature reader to access reference data indicative of markings/signatures of one or more physical objects and an entity in possession of the object signature reader associated with the reader ID data, and enabling communication of said object signature reader with the one or more blockchain systems; and (d) an object handling management module connectable to the signature/marking reading module and to the communication module. The object handling management module may be configured and operable for authenticating execution parameters of at least one handling operation carried out with respect to the physical object by carrying out the following:
authenticating the identity or type or batch of said object physical object by determining a match between: data of said marking/signature of the physical object obtained from said reading module with the markings/signatures of the one or more physical objects in said reference data;
authenticate identity of the entity in possession of the object signature reader by determining a match between the reader ID data identifying said object signature reader, and identity of said entity listed in the reference data;
   and thereby authenticate the handling operation. The object handling management module may also be configured and operable to operate the network communication module to access said one or more blockchain systems and validate registration of the authenticated handling operation in the second distributed ledger. The object signature reader thereby enables recordation of an object transaction associated with the physical object in the first ledger upon validation of authenticated of handling operations associated with that object transaction in the second ledger.

In some embodiments the object handling management module of the object signature reader is configured and operable to authorizes the reading module to read the marking/signature of the physical object, by providing the rendering module with data indicative of reading parameters by which to read the marking/signature of the object/The reading module is adapted to operate a certain reading scheme corresponding to the reading parameters and thereby determine the data of indicative of the marking/signature.

In some embodiments the object signature reader further includes the condition verifier module, which is adapted to obtain data indicative of predetermined conditions of the handling operation, and is adapted to enable to validate the registration of the authenticated handling operation in the second distributed ledger, upon verifying that the execution parameters of the authenticated handling operation comply with the predetermined conditions.

In some embodiments the object signature reader further includes a token management module connectable to the object handling management module, or to said network communication module, and configured and operable to enable authentication/validation of the handling operation upon at least one predetermined token transaction in said one or more blockchain systems.

In some embodiments the signature/marking of the physical object is an elemental XRF signature embedded with said physical object. The reading module may include an XRF measurement module configured and operable for carrying out XRF measurement of the physical object to read the XRF signature/marking For instance the reading module may be configured and operable to carry out the XRF measurement by illuminating at least part of said object with X-Rays or gamma-Rays and detecting X-Ray-Fluorescence response indicative of said XRF signature/marking

In some embodiments at least part of the reference data is stored in decentralized distributed manner by the one or more blockchain systems and the object handling management module of the object signature reader is adapted to access the one or more blockchain systems for retrieving at least parts of the reference data.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a block diagram schematically illustration a system 100 according to an embodiment of the present invention;

FIG. 2A is a block diagram schematically illustration in details a system 100 with various modules that may be implemented according to various embodiments of the present invention;

FIG. 2B is a flow chart of a method 200 according to an embodiment of the present invention;

FIG. 2C is a block diagram schematically illustration a system 100 according to the present invention implemented as an integral object signature reader system; FIGS. 3 and 4 and 6 are block diagrams schematically illustration systems 100 according to additional embodiments of the present invention;

FIG. 5 is a flow chart of a method 600 according to yet another embodiment of the present invention; and

FIG. 6 is block diagram illustrating a system 100 according to yet additional embodiment of the present invention.

### DETAILED DESCRIPTION OF EMBODIMENTS

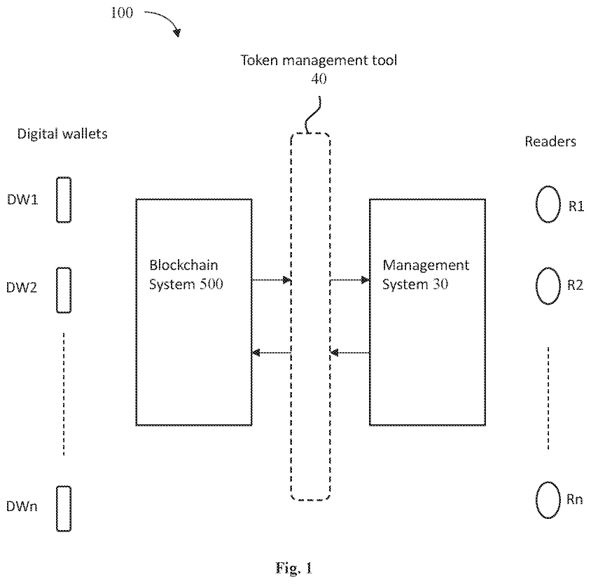

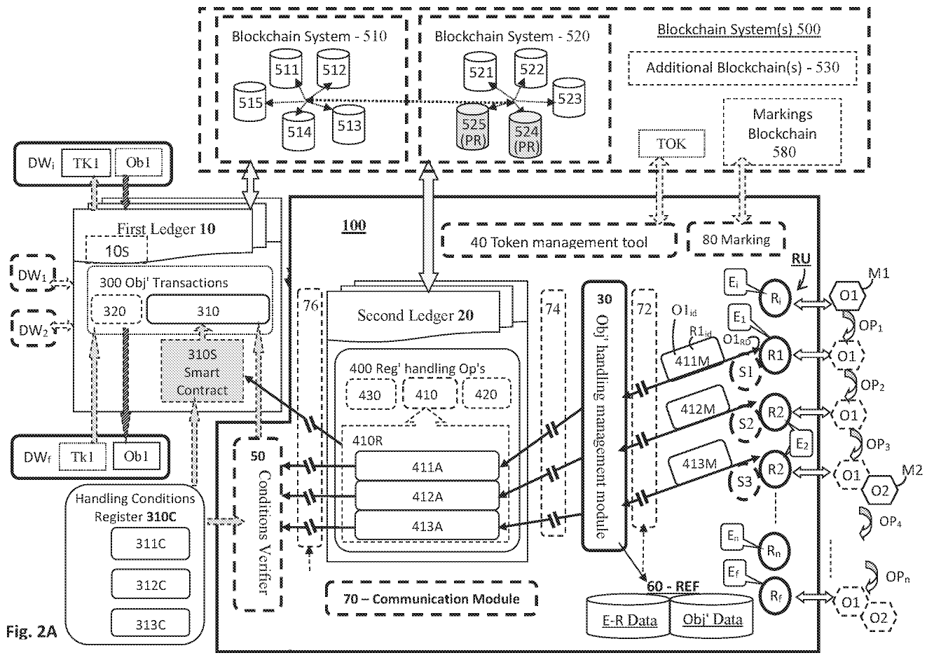

An embodiment of the system 100 for implementing transactions and/or smart contracts of the present invention is shown in FIG. 1, which is a schematic illustration of the general structure of the system comprising a blockchain system 500, a management module 30, and an optional token management tool 40.

The management module 30 (hereinafter also referred to interchangeably as management system/module and/or handling management module) communicates with a plurality of reader units R1, R₂ to Rn, which can read the physical marking (the object's signature) on the marked objects. Optionally, the reading units may also communicate with the blockchain system 500 for verifying that the marking on the object was read and identified (e.g. as an additional security layer).

The blockchain system 500 interacts with a plurality of digital wallets DW1, DW2, to DWn. The digital wallets may be implemented as software running on any type of computing device such as smartphones, PDAs, PCs, and servers. The digital wallets may also run on the nodes of the blockchain 500. The digital wallets DW1 to DWn may communicate also with the management system 30 and the token management tool 40.

The management system 30 is associated with reference data storing information indicative of the marking on the marked objects. The marking on the object may be unique to the object (e.g. presenting identifiers of the object) such that the marking may be used as a signature associated with the particular object. Alternatively, that marking may correspond to a plurality of objects, for example objects or products belonging to the same batch. In addition, the management system 30 may store data which is required in order to carry out a measurement of the marking of a marked object (e.g. reading schemes to be used for reading markings of specific objects or types thereof). This type of information may optionally be accessed solely by the management system 30 such that a reading unit may be able to read the marking of an object only after receiving this data from the management system 30. The management system 30 may also be associated with reference data storing additional information about the readers. For instance, reference data storing the locations and times and dates in which the readers were used, a serial number identifying the reader (an ID of the reader), and an ID identifying reader, and/or the person/entity operating the reader.

According to various embodiments of the present invention, the marking of/on an object which is read by the reading units (hereinafter readers) may be any one of various marking methods such as hologram, QR codes, UV or IR taggants, RFID tags, and X-ray signatures based of X-Ray Diffraction (XRD) or X-Ray Fluorescence (XRF) analytical techniques, applied to or embedded in the object and configured to be permanently and physically associated with the object. The term marking should be understood herein broadly as referring to marks/tags that are applied, coupled, attached or printed on the object, or inseparable marks/signature embedded with the object. Also, marking as used herein may refer to marks that are inherent/elemental to the object, such as signatures characterizing the object or its materials enabling to identify the object, and/or its type and/or its origin (e.g. such elemental markings/signature may often characterize valuable stones or diamonds); or to marks that are added/attached to the object.

The suitable object markings may be readable using standard or specifically configured reading units and may require specific scanning/reading protocol and parameters. In an example, the readers are spectrometers which may detect and identify electromagnetic radiation emitted from the marked objects. In particular, the readers may identify response signals emitted from the marked objects in response to irradiation of the marked object by primary electromagnetic radiation. In a preferred example, the readers are XRF analyzers (in particular energy dispersive XRF analyzers) which emit X-ray or Gamma-ray radiation toward the marked object and detect a response X-ray signal arriving from the marked object as a result. In order to read an XRF-sensitive marking (i.e. a marking which may be detected by XRF analysis), the reader should be adjusted according to predetermined reading-parameters. These parameters include: X-ray emitter parameters (that is the current and voltage of the X-ray emitting tube), type of filters filtering the incoming or outgoing signals, and duration of the reading (i.e. the duration of time in which the X-ray emitter emits radiation towards the object). Additional parameters which may be set include distances and angles between the X-ray emitter, detector and the marked object as described in International Patent Application PCT/IL2017/051050 which is herein incorporated by reference. The parameters required for reading the marking on the object may be stored on the management system 104 and provided only to specific readers authorized to carry out a reading of a specific object as described in US Provisional Patent Application No. 62/503,067 which is incorporated herein by reference.

In an aspect of system 100 of the present invention, the object may be marked by two or more types of markings One may be read after receiving data from the management system 30 and one or more which may be read by a suitable reader without requiring information from the measurement system. For example, the object may be marked be an XRF-sensitive marking which may only measure the marking after receiving data from the management system (and may be invisible and undetectable without a suitable reader), and, in addition marked by a barcode or QR-code which are visible and may be read by any barcode or QR-code scanners.

In an aspect of the invention the management system 30 may be designed as a blockchain system in itself (hereinafter also referred to as the management blockchain) wherein many copies of the data related to the markings on objects are stored in a plurality of nodes. The stored data related to the markings (e.g. the reference Obj′ Data indicated below) may be encrypted such that the signature and/or data related to the manner in which the signature is read by the reading units, is protected. In an example, the marking management system 30 may be implemented as, or include, a management blockchain that constitutes a part of the blockchain system 500. In this case the nodes of the management system 30 may function as privileged nodes of the blockchain system 500 storing and managing protected data, which is not shared with the rest of the blockchain system (e.g. data relating to the marking on objects).

The Blockchain system 500 may be used as a public ledger, which records ownership (and/or possession) and transaction data of a number of types of tradable items (herein after also referred to interchangeably as objects or assets) between parties. As indicated above, the parties may connect to the blockchain system 500 via digital wallets DW1 to DWn. Each such digital wallet includes data that can be used for proving ownership of a tradable asset/object or a part of such asset (for example a private key in a public key encryption system). The tradable assets may be one or more of (i) marked tangible objects or part of such object; (ii) a token managed by the token management tool 40, which may be the native token associated with the blockchain system 500. The token may represent an asset relating to a service or a utility. For example, the token may enable its owner to use services which are provided by or require the use of the management system 30. In a particular example, the token may be data (e.g. a set of one or more private keys stored in a digital wallet) which allows access to data in the management system 30 (e.g. corresponding to the physical mark on a particular object). In another example, a user may use tokens to buy or hire a reader, or pay for a service which requires the use of a reader.

The token management tool 40 controls the interface between the blockchain system 500 and the management system 30 and provides or denies access to data recorded by the management system 30 or data which may be obtained by the management system 30. Additionally, in cases where the use of reading units and the reading services may be managed by the management system 30, the token management tool 40 may control access to the reading units. For example, the token management tool 40 may be adapted to operate in response to a request provided by a token holder (e.g. being an entity that owns a token), for operating/instructing the marking management system and/or the reading units to verify that an object is marked by a specific code (that is, the token holder pays in tokens for the verification). In another example, the token management tool 40 allows free access to such data and requires a token only for transactions wherein the ownership of an object is transferred from one user (i.e. digital wallet). The price in tokens for each service may depend on the specific service required, as well as on additional factors.

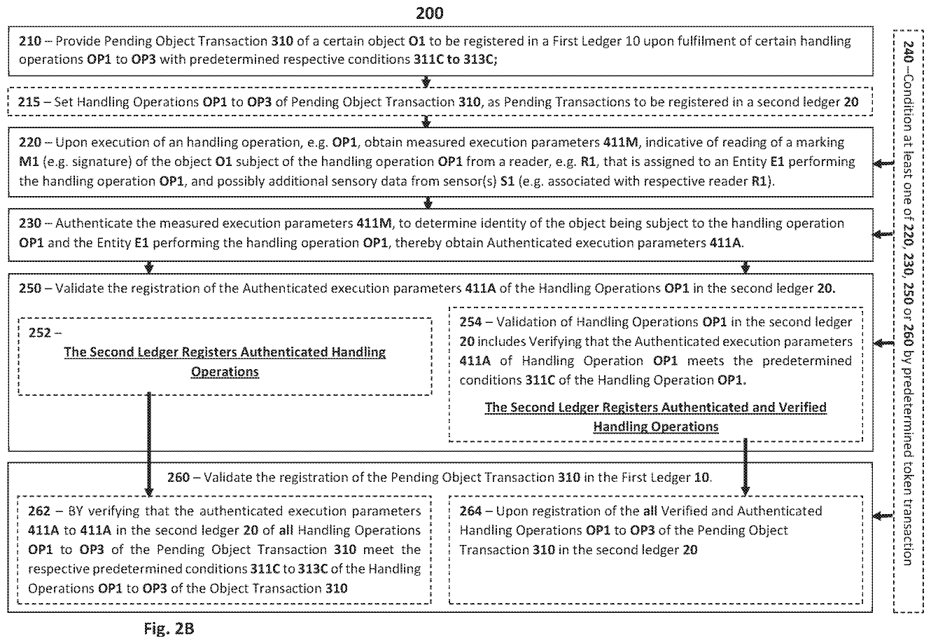

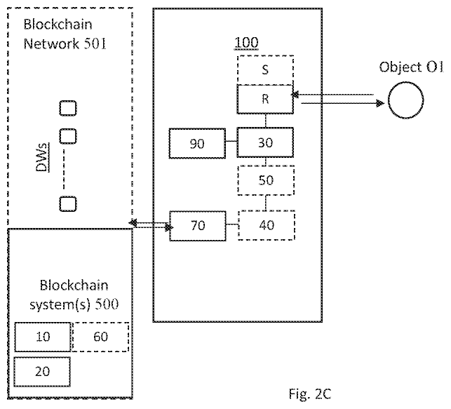

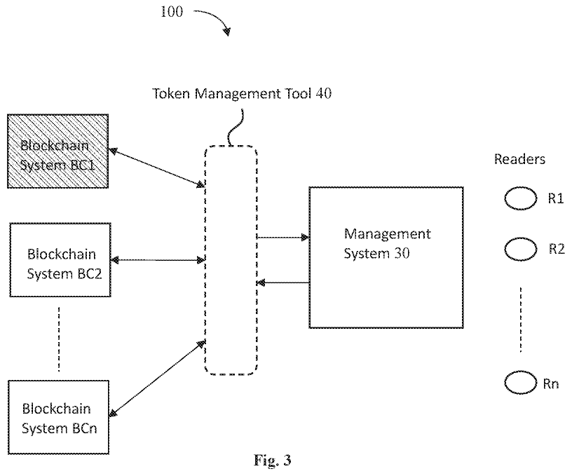

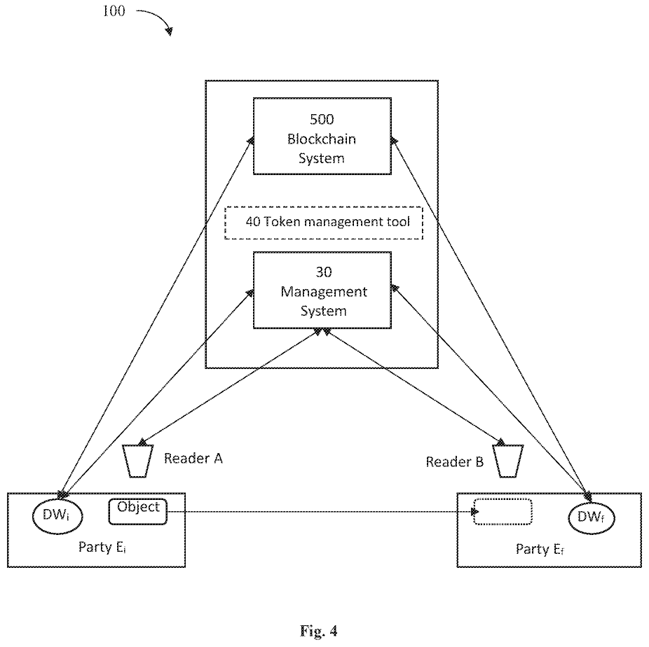

Reference is now made together to FIGS. 2A and 2B which are a block diagram 100 and a flowchart 200 of respective systems and methods according to embodiments of the present invention for managing object transactions 300 of one or more objects {O1, O2} according to some embodiments of the present invention. As will be appreciated from the disclosure herein, the systems 100 and methods 200 according to the present invention are particularly suitable for management of transactions of physical objects e.g. O1 between entities/parties e.g. from Eᵢ to E_{f}, whereby the object transactions may be implemented/registered Obj1 as such, on a distributed ledger platform, e.g. 10, such as blockchain(s) 500. For example, the transaction 310 of object O1 is shown in the distributed ledger 10 as the transfer of registry of Obj1 from the digital wallet DWᵢ of entity Eᵢ to the digital wallet DW_{f} of entity E_{f}. Possibly a counterpart transaction of tokens TK1 (e.g. cryptocurrencies) is also registered in the distributed ledger 10 (e.g. in association with object transaction 310) as shown in the figure by the transfer of the tokens TK1 from the digital wallet DW_{f} of entity E_{f} to the digital wallet DWᵢ of entity Eᵢ. Indeed, it is often the case, that transactions of physical objects are conditioned by, or depend on, certain handling operations, e.g. OP1 to OPn, which are to be performed e.g. by E₁ to Eₙ, which may be persons/companies (e.g. serving as supplying and/or manufacturing/fabricating and/or packaging and/or assembling and/or transporting and/or storing the object O1 along a supply chain between the parties Eᵢ and E_{f}). Accordingly, the registries Obj1, TK1, in the distributed ledger 10 of both the object transaction 300 of the physical object O1 and the counterpart token transaction TK1, may be conditioned such that the required handling operations OP1 to OPn of an object transaction 310 are met/fulfilled with required handling conditions 310C (e.g. the performance of those operations on the physical object O1 by authorized entities and/or under predetermined execution conditions (such as satisfactory environmental conditions/location etc.).

The systems 100 and methods 200 of the present invention provide a novel technique for linking the virtual environment blockchain(s) 500 and ledgers 10 by which such transactions 300 of objects are registered, with the real/physical environment at which the objects {e.g. O1 and O2} are actually handled during such object transactions, and facilitate to easily authenticate the execution conditions of the handling operations conducted with/on the objects {e.g. O1 and O2} for such object transactions 300 and verify, possibly automatically, that the handling operations are properly performed according to the prerequisite conditions of the object transactions.

Accordingly, the present invention provides a novel solution suitable, for example, for monitoring of a supply chain of objects.

In this regard, here the terms authenticate and similar terms are used to designate the identification/authentication of the actual objects {O1 and O2}, or the types/lots/batches of the actual objects involved in the handling operations, as well as the respective actual entities {E1 to E2} which are involved/carry-out the handling operations, and possibly, in some embodiments, also determine some execution conditions (e.g. environmental/inertial conditions and/or locations) at/under which the handling operations are performed). In general, authentication is associated with the operation of the reader units RU, and possibly additional sensors associated therewith, by which the execution conditions of a handling operation are measured/determined (the identity of the object and entity involved, and possible additional conditions that may be sensed by sensors). To achieved this, measured execution conditions by the reader units (e.g. with or without additional sensors 411M to 413M are compared, e.g. by the reader units RU or by the object handling management module 30 with reference data 60, as described below and a match between them, indicates the authenticity of the handling conditions—thereby yielding authentic handling conditions 411A to 413A). The authentication operation itself may be performed solely by the reader units.

The terms validate or validation and the like are used herein to designate an operation used in a blockchain system which is a prerequisite for storing/registering/recording a transaction (confirmed transaction) in the blockchain. As will be appreciated by those versed in the art, upon request to register/store a transaction in a blockchain system, the requested transaction is pending, until it is validated and a decentralized consensus about it is obtained (in this regards it should be noted that there may be no formal ‘pending status’, the requested transaction will generally not be registered until the decentralized consensus about its validation is achieved by the nodes of the blockchain). Upon such validation, the pending transaction becomes valid/validated transaction and is registered and stored in the blockchain. To this end, the terms pending transaction or a request for transaction are used herein to designated pre-validated transactions. The meaning of the general term transaction may refer to registered transactions or pending transactions and should be construed according to context. In this connection, it should be noted that the first ledger 10 described herein is used to register object transactions 300 whose validation depends on the occurrence of certain handling operations performed with respect to the object, subject of the object transactions. To this end, these object transactions 300 (which are also generally referred to herein just as transactions), are typically held in the status of pending transactions (un-registered) until validation and verification of the handling operations associated with or required for those transactions. An object transaction, e.g. 310, can be validated upon validation in the second ledger 20 of all the handling operations OP1 to OP₃ associated with the respective transaction, and verification that the valid handling operations OP1 to OP₃ meet the handling condition requirements 311C to 313C of the transaction 300. In turn, the handling operations OP1 to OP₃, of a certain object transaction 310, are generally presented by transactions, e.g. 411A to 413A, in the second ledger 20. The handling operations OP1 to OP₃ may be considered to remain as pending transactions of the second ledger 20 until their respective measured execution conditions 411M to 413M are authenticated by the system 100 yielding respective authenticated execution conditions 411A to 413A, and, optionally, in one embodiment they further remain pending also until the authenticated execution conditions 411A to 413A are verified as matching to the prerequisite handling conditions 311C to 313C of the respective handling operations OP1 to OP₃. Then, the at least authenticated and possibly also verified handling operations OP1 to OP₃ are validated by system 100 and registered as such in the second ledger 20 (e.g. exemplified in the figure by the registration of the authenticated execution conditions 411A to 413A).

The terms verify or verification are used herein to designate the actual/authenticated objects {O1 and O2}, actual/authenticated entities {E1 to E2} and/or the actual execution conditions involved in the handling operations OP1 to OP₃ meet the requirements (prerequisite handling conditions 311C to 313C) of the handling operations of a respective object transaction, e.g. 310). To this end, verification of an authenticated handling operation 411A may be performed by the system 100 prior to registry of the authenticated handling operation 411A in ledger 20, in which case the authenticated handling operation 411A actually presents verified authenticated handling operation 411A. Alternatively verification of an authenticated handling operation may be performed either by system 100 or by a smart contract of ledger 10 or any other entity, after the registry of the authenticated handling operation 411A in ledger 20, in which case ledger 20 presents authenticated but not necessarily verified handling operations. As indicated above, an object transaction, e.g. 310, is validated upon verification and authentication of all its handling operations.

To achieve this, the system 100 is connectable to the first distributed ledger 10, which is adapted to record object transactions 300 (e.g. change in ownership/tokens) associated with transactions of one or more physical objects {O1, O2} between the parties {Eᵢ, E_{f}}. The system 100 includes a second distributed ledger 20. The second distributed ledger 20 is adapted to record data indicative of object handling operations {OP₁ to OPₙ} (e.g. change in possession and/or conditions of transportation/handling/assembly) which are carried out with respect to the object transactions, e.g. 310, of the one or more physical objects {O1, O2}. Typically, only authenticated records of the handling operations are stored in the second distributed ledger 20, so that the second distributed ledger 20 may serve as an authenticated registry of the execution parameters of handling operations {OP₁ to OPₙ} associated with transactions 300 of objects. The system 100 also includes an object handling management module 30 that is configured and operable for authenticating the handling operations {OP₁ to OPₙ} carried out with respect to the one or more physical objects {O1, O2} by carrying out the following: (i) obtaining parameters of execution {411M to 413M} of said handling operations {OP₁ to OPₙ} (e.g. determine one or more conditions upon which the handling operations {411M to 413M} are carried out), (ii) authenticate said parameters of execution {411M to 413M}, and (iii) record said parameters of execution {411M to 413M} of the handling operations {OP₁ to OPₙ} (or only the corresponding parameters of execution {411A to 413A}), in the second distributed ledger 20. Accordingly, the system 100 facilitates verification and recordation of object transactions 300 (e.g. change in ownership) associated with one or more physical objects {O1, O2} upon verifying that the authenticated parameters of execution of the handling operations {OP₁ to OPₙ} that are carried out with respect to the one or more physical objects {O1, O2} satisfy one or more respective predetermined conditions {311C to 313C}.

With reference to FIG. 2B, method 200 according to embodiments of the present invention for validation of transaction of objects, will now be described in relation to the modules illustrated in FIG. 2A.

In 210 a pending object transaction 310 of a certain object O1 is provided. The object transaction 310 is pending to be registered in the first ledger 10 and would be registered upon fulfilment of the predetermined conditions 311C to 313C of its respective handling operations, e.g. OP1 to OP₃,which are required to be performed for registration of the transaction 300. The pending object transaction 310 may be for example in the form of a smart contract 310S, or the predetermined conditions 311C to 313C may be found in a certain handling conditions data registry 310C.

In optional 215 the handling operations OP1 to OP₃ of the pending object transaction 310, are set/considered as pending handling transactions to be registered in a second ledger 20. For example, in case the pending object transaction 310 is smart contract 310S, it may include sub-transactions of the smart contract 310S (e.g. conditions 311C to 313C) that are conditioned by the validation and registration of the operations OP1 to OP₃ of the pending object transaction 310 in the second ledger 20.

Operation 220 is generally performed by the reader units RU of the present invention which are typically operated by the entities, e.g. E1 to En, performing the handling operations, and to which the respective readers are assigned. For example, upon execution of handling operation OP1, in operation 220 measured execution parameters 411M are obtained, which are indicative of reading of a marking M1 (e.g. signature) of the object O1 that is the subject of the handling operation OP1. The measured execution parameters 411M are obtained/read by the reader, e.g. Rl, that is assigned to the entity E1 performing the handling operation OP1, and possibly also includes additional sensory data obtained from additional sensor(s) S1 which may be associated with the respective reader R1.

Operation 230 is typically performed by the object handling management module 30 and includes authenticating the measured execution parameters 411M, to determine, based on the measured execution parameters 411M, the identity of the object O1 being subject to the handling operation OP1 and the entity E1 performing the handling operation OP1, to thereby obtain authenticated execution parameters 411A.

Then, operation 250 is conducted, typically by the object handling management module 40 or the respective reader unit R1 to validate the registration of the authenticated execution parameters 411A of the handling operation OP1 in the second ledger 20.

As indicated in 252, optionally according to some embodiments of the present invention, the second ledger 20 registers authenticated handling operations (but not necessarily verified ones).

Alternatively, as indicated in optional 254, validation of the handling operation OP1 in the second ledger 20 further includes verifying that the authenticated execution parameters 411A of the handling operation OP1 meet/fulfill the predetermined conditions 311C of the respective handling operation OP1. This may be for example performed by the conditions verifier module 50 of system 100 as described below. In this case the second ledger 20 registers handling operations which are both authenticated and verified.

Finally, when all the all handling operations OP1 to OP₃ of an object transaction 310 are authenticated, and verified, or can be verified, operation 260 may be carried out in order to validate the registration of the pending object transaction 310 in the first ledger 10. In this regard, operation 262 may be carried out in cases (e.g. as described in 252 above) where the second ledger 20 registers authenticated, but not necessarily verified, handling operations. In such cases, validating the registration of the object transaction 310 includes verifying that the authenticated execution parameters 411A to 413A are registered in the second ledger 20 for all the handling operations OP1 to OP₃ of the pending object transaction 310, and that those authenticated execution parameters 411A to 413A, all meet their respective predetermined conditions 311C to 313C for the object transaction 310. Operation 262 may, for example, be performed by the conditions verifier module 50 of system 100 as described below. Alternatively, operation 264 may be carried out in cases (e.g. as described in 254 above) where the second ledger 20 registers handling operations which are both authenticated and verified. In such cases, in 264, upon registration of all the verified and authenticated handling operations OP1 to OP₃ in the second ledger 20, the pending object transaction 310 is validated to be registered in the first ledger 10. This may, for example, be performed by a smart contract in the first ledger 10.

Optionally, in operation 240 one or more of the above described operations 220, 230, 250 (e.g. 252 or 254) or 260 (e.g. 262 or 264) may be performed only upon the occurrence of a predetermined token transaction, in a certain one or more of the blockchain system(s) 500 with which system 100 (e.g. in ledger 10). This may be performed by the token management tool 40 of system 100.

Further details and implementations of the method 200 according to various embodiments of the present invention are described below with reference to system 100. Those versed in the art will readily appreciate how to implements the features described below in the method 200.

Turning back to FIG. 2A, the first ledger 10 may be configured and operable for automatically recording an object transaction, e.g. 310, upon such verification that the conditions {311C to 313C} of the transaction are satisfied by the authenticated parameters of execution {411A to 413A}. In this regard, the object transaction 310 may include for example (i) transactions of ownerships Ob1 of one or more objects, e.g. O1; and (ii) transactions of tokens Tk1 associated with changes of ownerships of the one or more objects e.g. O1.

For example, the first distributed ledger 10 may be a smart contract ledger 10S having access to the second distributed ledger 20, and adapted to obtain the authenticated parameters of execution 411A, 412A or 413A of handling operation OP₁, OP₁ or OP₃) which are carried out with respect to the physical object O1, and recording object transaction 310 of the at least one object O1 in the first ledger 10 upon determining that said at least one handling operation (e.g. OP₁, OP₁ or OP₃) complies with at least one predetermined condition {e.g. 311C , 312C or 313C} indicated by a smart contract 310S in the ledger 10S for transaction of that object.

Alternatively or additionally, the system 100 may include a condition verifier module 50 adapted to obtain the authenticated parameters of execution 411A, 412A or 413A of the handling operation (e.g. OP₁, OP₁ or OP₃)0 carried out with respect to the object O1, verify/compare the authenticated parameters of execution 411A, 412A, or 413A with the predetermined conditions {e.g. 311C , 312C or 313C}, and record/verify the object transaction 310 of the object O1 in the first ledger 10, upon determining that the parameters of all handling operation (e.g. OP₁ to OPₙ) associated with this object transaction 310 comply with their respective predetermined condition {e.g. 311C , 312C or 313C}.

The distributed ledgers 10 and 20 are typically implemented on one or more blockchain system(s) 500. The blockchain systems implement distributed ledgers 10 and 20 may be the same (e.g. a single) blockchain system 500 exemplified with connected nodes/servers 511 to 515 and 521 to 525, whereby each carries a duplicated copy of the ledgers 10 and 20. In this connection it should be understood that in some embodiments, records of both distributed ledgers 10 and 20 may be written together in the blocks of the same blockchain 500.

Alternatively, or additionally, in some embodiments the blockchain(s) 500 implementing distributed ledgers 10 and 20 are different blockchain(s) 510 and 520 respectively, which are exemplified by connected nodes/servers 511 to 515 of blockchain 510 (implementing the first distributed ledger 10), and connected nodes/servers 521 to 525 of blockchain 520 (implementing the second distributed ledger 20).

Accordingly, as the ledgers 10 and 20 are implemented on blockchain(s) (e.g. 500 or 510 and 520), the ledgers 10 and 20 are decentralized distributed ledgers having generally no or reduced centralized vulnerability for record/transaction forgery. This makes system 100 particularly advantageous for use in transactions of physical objects, which may naturally involve many not necessarily trustable entities handling the objects' transaction (e.g. as is often the case with supply chains), because no single entity solely is responsible for writing/recording the data in the ledgers. In this regard it should be understood that writing of records to any one of the ledgers 10 and 20, which is associated with the writing of blocks in the blockchain(s), hereinafter generally 500, may be implemented according to any suitable block chain technique, and generally includes achieving decentralized consensus between the nodes of the respective blockchain according to suitable blockchain protocol/technique (e.g. proof-of-work plus validation or proof-of-stake). Depending on specific implementation of the system 100, the blockchains 510, 520 or 500, implementing the ledgers 10, 20 or both, may each be a private or public blockchain, and may be configured and operable with the same or with different blockchain protocol/technology.

It should be noted that according to some embodiments of the present invention, the object handling management module 30 includes privileged PR nodes (e.g. 524 and 525) of the blockchain system, 500 or 520, which are operable (e.g. exclusively) for requesting the recordation/registration of the parameters of execution (e.g. 411A, 412A or 413A) of the handling operations (e.g. OP₁, OP₁ or OP₃) within the second distributed ledger 20. To this end, other nodes (e.g. 521 to 523) of said blockchain system, 500 or 520, which have no such privilege, may not be allowed to initiate/request writing of data records in the blockchain 500 or 520.

According to some embodiments of the present invention, the system 100 also includes a token management module 40, which is configured and operable to selectively enable or prevent the writing (e.g. publication/registration), within the second distributed ledger 20, of the authenticated execution parameters (e.g. 411A, 412A or 413A) of the handling operations (e.g. OP₁, OP₁ or OP₃), or, in some cases, even selectively allow or prevent the writing of measured execution parameters (e.g. 411M, 412M or 413M) in the second ledger 20. To this end, the token management module 40 may be configured and operable to selectively enable/initiate or prevent the writing/publication/registration of any execution parameter, e.g. 411M or 411A, according to the receipt of data TOK indicative of a predetermined transaction of a token TOK in one of the blockchain system(s) 500 associated with the system 100. The required predetermined transaction of the token TOK may be a transaction associated with a certain required entity (a predetermined entity of Eᵢ and E_{f} or E₁ to Eₙ) and may serve as a signal authorizing the system 100 to carry out the respective measurement/authentication of the corresponding handling operation, e.g. OP1. In some implementations the properties of the token TOK which is to be received in order to enable/initiate measurement/authentication of handling operation OP1, or the registry of any of its execution parameters, e.g. 411M or 411A, may be included/specified by the smart contract 310S or the handling conditions register 310C associated with the corresponding object transaction 310. Accordingly, upon receipt of the predetermined token TOK the token management module 40 may enable/initiate the measurement/authentication and/or registry/recordation of the corresponding execution parameter, e.g. 411M or 411A.

To this end, system 100 may typically include a data/network communication module 70 facilitating its communication with the blockchain system(s) 500 (or at least that, e.g. 520, in which ledger 20 is implemented). The token management module 40 may be connected to the data/network communication module 70, e.g. to at least one component/switch, e.g. 70, 72, 74 or 74, thereof and is configured and operable to thereby utilize the data/network communication module 70 for enabling/initiating the measurement/authentication and/or registry/recordation of a certain execution parameter, e.g. 411M or 411A, or preventing it. Alternatively, or additionally, the object handling management module 30 may be connected with the token management module 40 and be adapted for requesting/receiving authorization instructions from the token management module 40 prior to any one of the activities of measurement/authentication and/or registry/recordation made in connection with a certain execution parameter, e.g. 411M or 411A.

To this end, the object handling management module 30 is adapted to authenticate the handling operations (e.g. OP₁, OP₁ or OP₃), which are carried out with respect to the one or more physical objects O1, O2. The one or more physical objects O1, O2 are marked by one or more markings M1, M2, that are readable by one or more reader units RU associated or included with the system 100. e.g. readers Rᵢ, R₁, R₂ and R_{f} are shown in FIG. 2A as associated respectively with the entities Eᵢ, E₁, E₂ and E_{f} e.g. persons/companies). The object handling management module 30 is adapted to authenticate handling operation, e.g. OP₁, of an object e.g. O1, by obtaining, from at least one reader unit e.g. R₁, data indicative of a specific marking M1 of the object O1, which is being read by the reader unit R₁ in relation to said handling operation OP₁.

The system 100 may include, or may be associated with a reference data registry 60 (e.g. that may be implemented for instance utilizing one or more data base(s), cloud data storages, and/or in distributed ledgers of blockchain(s) 500). The reference data generally includes:
(a) an Entity-Reader reference data E-R-Data storing data associating the reader units of the system, Rᵢ, R₁, R₂ and R_{f}, with the identifiers of the respective entities Eᵢ, E₁, E₂ and E_{f} presently in possession of those readers. Accordingly, the system 100, e.g. object handling management module 30 can readily associate a reader's identifier R1_{id} (i.e. a unique identification code assigned to each reader) with the identity of the entity E1 (person/company/department) that has/uses that respective reader R1, as shown in Table 1:

TABLE 1
E-R-Data

| Reader | Entity |
|---|---|
| R1_{id} | ID of E₁ |

(b) Objects reference data Obj′-Data stores identification data, e.g. O1_{id} indicative of respective objects, e.g. O1, which are associated with respective markings, e.g. M1 (e.g. preferably elemental XRF markings or possibly other markings/tags), which can be readily read by the reader units Rᵢ, R₁, R₂ and R_{f} of the system 100. Accordingly, the system 100, e.g. object handling management module 30, can readily associate a marking, e.g. M1 read from object O1 (e.g. by any of the reader units) with the identification of the object, e.g. O1_{id}. Indeed, in some embodiments, the objects reference data Obj′-Data also stores, in association with each/some object O1 (e.g. in association with the marking M1 of each/some object marking) specific reading instructions (reading schemes/parameters) O1_{RD} required in order to properly operate one or more of the reader units Rᵢ, R₁, R₂ and R_{f} to utilize the proper reading scheme O1_{RD} and correctly read the respective marking M1 on the object O1. In this manner, providing the reading scheme O1_{RD} to a reader R₁ actually enables and authorizes the reader R₁ to read/decipher the object's identity O1_{id}. In this case, given data indicative of the object O1 (or type thereof) being the subject of an object transaction 310 (whose data can be obtained from the handling conditions register 310C of the object transaction 300), the system 100, e.g. object handling management module 30, retrieves the proper reading scheme O1_{RD} associated with that object/type-of-object) from the objects' reference data Obj′-Data and sends/communicates the same to the respective reader, e.g. R1, to enable identification of the object O1 by the reader R1. This is shown for instance in Table 2:

TABLE 2
Obj'-Data

| ID of Object/Batch/Type | Marking | Reading Scheme |
|---|---|---|
| O1_{id} | M1 | O1_{rd} |

In this regard, it should be noted that in some embodiments, it is advantageous that objects reference data Obj′-Data is also registered in a distributed ledger (e.g. in blockchain 580, or in another one of blockchains 500. This may be particularly significant in cases where the markings are not easily/practically forgeable, such as XRF elemental markings, which are inherent part of the objects' materials. This is because generally the first entity in possession of the object O1 with the marking M1, e.g. E may be considered as trustworthy with regard to the originality of the object O1. Accordingly, placing the Obj′-Data in a distributed ledger/blockchain, e.g. 580, enables such an entity to firstly register the object O1 with its marking M1in the objects reference data Obj′-Data such that this reference data is decentralized and distributed, and cannot be practically forged. Indeed, this is more significant for elemental markings such as XRF marks, since such elemental markings, as they are part of the object's materials, in many cases cannot be practically removed from the object. To this end, system 10 may optionally include a marking manage module 80, configured and operable to enable marking registration of objects with the objects reference data Obj′-Data in the distributed markings ledger 580. The marking management module 80 may be implemented as a management blockchain that constitutes a part of the blockchain system 500 or 580 and may include privileged nodes of that blockchain system 500 or 580 which are privileged for storing and managing the objects reference data Obj′-Data. Optionally, the objects reference data Obj′-Data may also be protected data that cannot be shared with the rest of the blockchain system 500.

It should be understood that the term marking as used herein in the present disclosure, should be interpreted broadly, as relating to any type of marks/tags and signatures associated with an object. These may, for example, be QR codes printed on the object, RFID tags attached/coupled to the object, as well as XRF marking and signatures. As for XRF, it should be noted that some objects (e.g. diamonds or other precious stones) may inherently include strong characterizing XRF signatures, serving as inherent markings of the object, without any active marking activity performed on the object. Alternatively, in man-made objects, XRF signatures marking the objects may be induced by including some XRF responsive material compositions/mixtures to the materials of the object, by any suitable technique, or coating the object therewith.

To this end, an entity E that identifies, characterizes or applies a certain marking (be it be an added mark/code or tag, or an inherent elemental signature) of an object of interest O1, may access the distributed marking ledger 580 and register the object's ID O1_{id} with its marking M1 and possibly with a suitable reading scheme O1_{RD} for reading the marking Optionally, in some embodiments, the distributed marking ledger 580 may be supervised by the marking management module 80 which may be privileged for registering object marking in the distributed marking ledger 580, and which may be configured and operable for providing such registration services to interested entities.

Moreover, in some embodiments, the Entity-Reader reference data E-R-Data may also be registered in a distributed ledger. For instance, the reader units, e.g. Rᵢ, R₁, to Rₙ and R_{f} themselves may be considered as objects whose object transactions to, or from, the entities Eᵢ, E₁ to Eₙ and Eᵣ are registered in ledger 10 and managed by system 100 similarly as described herein with regard to Object O1. For example, an entity that wishes to lease a reader, may do so via an object transaction, e.g. 320 registered in ledger 10 or a similar one (which would, in this case, actually store the Entity-Reader reference data E-R-Data).

According to various embodiments of the present invention, regardless of the manner by which the reference data 60 is stored, the object handling management module 30 is adapted to utilize data reference data 60 to authenticate the handling operation OP₁ of the object O1 to verify that the handling operation OP₁ is carried out on the identified object O1 by said entity E1. This includes for example:
i. utilizing said specific marking M1 of the object to authenticate identity O1_{id} of said object O1. More specifically, authenticating the identity O1_{id} of the object O1 is authenticated by determining a match between: data of said specific marking M1 of the object O1 as obtained from the reader unit R1, with pre-stored reference data Obj′-Data indicative of said specific marking M1 by which the object O1 is marked; and
ii. utilizing the data R1_{id} identifying said reader unit R1 to authenticate identity of the entity E1 which has possession of the reader unit R1 and which implements said handling operation OP₁. The identity of the entity E1 in possession of the reader unit R1 may be authenticated by determining a match between the data R1_{id} identifying said reader unit, and reference data E-R-Data listing identities Rᵢ, R₁, R₂ and R_{f} of said one or more reader units {Rᵢ, R₁, R₂, R_{f}} in association with respective entities {Eᵢ, E₁, E₂, E_{f}} that are in possession of said one or more reader units {Rᵢ, R₁, R₂, R_{f}}.

In some implementations, prior to operation of the reader unit R₁, the object handling management module 30 is adapted to authorize the reader unit R₁ to read the specific marking M1 of the object O1, and/or for that matter authorize the reader unit R₁ to obtain/measure any other of the execution parameters 411M of a respective handling operation, e.g. OP1. For instance, as described above, in some implementations, object handling management module 30 authorizes the reader unit R₁ to read said specific marking M1, by communicating to the reader unit R₁ data indicative of reading parameters O1_{RD} by which to read said specific marking M1. In turn, the reader unit R₁ may be adapted to operate a certain reading scheme corresponding to the reading parameters O1_{RD} and thereby determine, and communicate the data indicative of a specific marking M1 of the object O1 to said object handling management module 30. In this case, the steps of authentication and verification of the object identity may be considered to be performed in unison. This is because the incorrect reading parameters O1_{RD} of the actual object O1 being read, may be obtained from the handling conditions register 310C of the object transaction 300, in case the identity of the alleged object, subject of the object transaction 300, does not match the actual object being handled/read O1, which in turn might result in incorrect reading of the actual object O1.

In in some embodiments of the present invention, the authenticating the handling operation OP₁ is followed by verification the handling operation OP₁, which is carried out on said object, i.e. O1 is authorized for said entity E₁.

For example, the first distributed ledger 10 may be a smart contract ledger 10S including a smart contract 310S for object transaction 310 of the object O1. The smart contract 310S is indicative of predetermined conditions 310C including conditions {311C, 312C, 313C} of execution of certain one or more respective handling operations {OP₁, OP₁, OP₃} to be carried out for the object transaction 310 of the object O1. Accordingly, verifying handling operations {OP₁, OP₁, OP₃} may be achieved by determining that the handling operations {OP₁, OP₁, OP₃} are carried out by respective entities {E₁, E₂, E₂} indicated by the conditions of execution {311C , 312C , 313C} and their authenticated parameters of execution {411A , 412A , 413A} also comply with the conditions of execution {311C , 312C , 313C}.

According to some embodiments of the present invention, the physical objects {O1, O2} are marked by physical markings {M1, M2} that are applied to, or embedded within, or are elemental/inherent to physical objects {O1, O2}, and indicative of the identities of those physical objects {O1, O2}. To this end, the physical markings {M1, M2} of respective physical objects {O1, O2} may identify the specific physical objects respectively {O1, O2}. Alternatively or additionally, the physical markings {M1, M2} of respective physical objects {O1, O2} identify the types or batches of the physical objects respectively. In any of such cases, the markings are considered herein as identifying the objects, be it identification of the specific objects, or identification of the mere types/batches thereof.

In some embodiments, the physical markings {M1, M2} are X-Ray-Fluorescence (XRF) signatures identifiable via XRF analysis of the respective physical objects {O1, O2}. In such cases the reader units {Rᵢ, R₁, R₂, R_{f}} are configured and operable for carrying out XRF measurements on said {M1, M2} to read the XRF signatures. To this end, the markings {M1, M2} may be elemental markings of the objects {O1, O2} associated with material composition of the objects, thus being inseparable from said objects {O1, O2}. The reader units {Rᵢ, R₁, R₂, R_{f}} may be configured and operable to carry out the XRF measurements by illuminating at least parts of said objects {O1, O2} with X-Rays of gamma-Rays and detecting X-Ry-Fluorescence response indicative of the XRF signatures of said objects {O1, O2}. The system 100 (e.g. the handling management module 30) may be configured and operable to process the XRF signatures of the objects {O1, O2} to determine said markings {M1, M2} respectively. Examples of a techniques which may be implemented and/or carried ut by the carried out by the handling management module 30 and/or the reader units RU to identify XRF signatures/markings is disclosed for instance in details in PCT patent application publications WO 2016/157185, WO 2017/221246, and WO 2018/051353, which are co-assigned to the assignee of the present Application and incorporated herein by in full reference. To this end, in some embodiments the reader units RU, or at least the reading modules thereof (e.g. 90 in FIG. 2C) and/or the handling management module 30 may be configured and operable according to the present invention for implementing any one or more of the techniques described in those PCT publications for reading and/or measuring and/or processing and/or analyzing the XRF signatures/markings of the objects. .

It should be noted that the handling operation, e.g. monitored by the readers, may include any one or more of the following:
(i) OP1—Change in possession of the object O1. In the example of FIG. 2A possession of identified object O1 is transferred from entity Eᵢ to entity E₁ and the change in possession is authenticated in this example by the reader R1 of entity E1. Accordingly, the system 100 verifies/authenticates the change in possession of the object O1 from Eᵢ to entity E₁.
(ii) OP2—Transportation/Storage of the object O1 (e.g. in the example of FIG. 2A the object O1 is then transported from entity E₁ to entity E₂ (by entity E₂ which also acquires possession of the object O1). The transportation of identified object O1 is verified/authenticated in this example by the readings of reader R₂ of entity E2. Accordingly, the system 100 verifies/authenticates that entity E2 performed the transportation/storage operation OP2, as well as the change in possession from E1 to E2.
(iii) OP3—Assembly of the object O1 with another object O2. In this example, entity E₂ also attends to assembly of the objects O1 and O2. Assembly of the identified object O1 with another object is verified/authenticated by the readings of reader R2 of entity E2. In case, as in this example, where the another object O2 is also identifiable by system 100, identification of object O2 may also be verified/authenticated by the reader R₂ of entity E2. Accordingly, the system 100 verifies/authenticates that entity E2 performed the assembly operation OP3.

As will be appreciated by those versed in the art, additional handling operations OP1 to OPn, or other types of handling operations, may be required for the transaction 310 of object O1 (and possibly of additional objects e.g. O2 which may be assembled or incorporated with O1 along the object transaction) between initial Eᵢ and final E_{f} entities, being parties of the object transaction 310. OP1 to OPn may, for example, represent supply chain operations required for carrying out of the object transaction 310 of the object O1 between the parties Eᵢ and E_{f}. The authenticated/verified operations, OP1 to OPn (i.e. whose execution parameters, 411M to 413M (e.g. indicative of the entity performing each operation, and the object on which the operation is performed and possibly additional parameters) are read/measured by the system 100.

The reader units RU that are used to verify the objects and the entities, and possibly by additional sensors, e.g. S1 to S3, may be associated with the respective readers R1 to R3 or the respective entities E1 to E3 for measuring additional execution parameters (e.g. geographic location at which an operation is performed, environmental/inertial conditions of the operation, and/or other objects/materials associated with the operations). The system 100, e.g. in some cases the readers RU themselves, or more generally the handling management module 30, is adapted to access reference data 60, as described above, in order to authenticate the execution parameters, 411M to 413M, and determine authenticated execution parameters 411A to 413A. In this regard, authentication should be understood as the operation of the system 100 (e.g. RUs or module 30) to compare/analyze the measurements/readings obtained from the readers RU (and possibly also from the sensors) in order to at least identify the actual entities E₁ to Eₙ performing/executing the handling operations OP1 to OPn, and the identifiers of the actual object(s) O1 and possibly O2 upon which the handling operations are performed. Upon such authentication, the authentic execution parameters e.g. 411A to 413A are determined, in which the actual entities of E₁ to Eₙ and the actual object(s) O1, O2 involved in respective handling operations OP1 to OP3, and the identifiers, possibly together with the additional sensory measurements/data may be obtained during these operations from the optional sensors S1 to S3 that may be associated with the readers.

The authenticated execution parameters 411A to 413A are registered and recorded 410 as registry 410R of recorder handling operations 400 managed in the second distributed ledger 20 in association with the respective object transaction 310 for which the respective handling operations OP1 to OPn should be performed. As illustrated in the non-limiting example of FIG. 2A, the authenticated execution parameters e.g. 411A to 413A are recorded in the second ledger 20 (e.g. in this case authentication of measured execution parameters e.g. 411M is performed, and then the resulting respectively authenticated execution parameters 411A are recorded in the second ledger 20. Yet in some alternative embodiments, the raw/measured execution parameters, 411M to 413M are first recorded in the second distributed ledger 20, and then the above indicated authentication may be performed (e.g. together with the verification that the handling operation meets the predetermined handling conditions {311C to 313C} required for the respective object transaction 310).

As will be readily appreciated by those versed in the art, the second distributed ledger 20 may be implemented on nodes (e.g. servers), 521 to 525, and possibly 511 to 515 of a blockchain system 520 or 500. The system 100, e.g. the handling management module 30, performing recordation of the authenticated execution parameters 411A to 413A may be associated with, or may include, specifically privileged nodes 524 and 525 of the blockchain system 520 or 500, which are exclusively permitted to write/store/change records in the second distributed ledger 20. Accordingly, as other nodes of the blockchain system 520 or 500 may only read the execution parameters e.g. 411A to 413A, it may be trusted that the recorder execution parameters in the distributed ledger are authentic. To this end, in some implementations the blockchain system 520 or 500 implementing the second distributed ledger 20 may be an open system, allowing access to any interested party, e.g. Eᵢ, E₁ to Eₙ, E_{f} or other parties to read the execution parameters e.g. 411A to 413A which are registered in the second distributed ledger 20. The other parties may be any other entity, or another blockchain system e.g. specifically the blockchain system 510 implementing the first distributed ledger 10 (which may be a smart contract ledger) in which the object transactions of the objects are registered. In some implementations the blockchain system 520 or 500 implementing the second distributed ledger 20 may be a closed system, allowing access to only selected party members of the second distributed ledger 20, e.g. Eᵢ, E₁, E_{f} and/or 510 to read the execution parameters e.g. 411A to 413A which are registered in the second distributed ledger 20. The selected parties may be for example the parties Eᵢ, E_{f} of the respective object transaction 310, and/or the blockchain system 510 implementing the first distributed ledger 10 (which may be a smart contract ledger) in which the transactions of the objects are registered/implemented. This allows the relevant parties to access the registry 410R in ledger 20 of the recorder handling operations 410 associated with respective object transaction 310 to enable them to verify that the execution parameters 411A to 413A of the handling operations of the object transaction meet the transaction conditions 310C.

In this connection, in some embodiments of the present invention the system 100 includes the optional verification module 50 which is associated with a handling Conditions Register 310C in which handling conditions 311C to 313C of object transactions, e.g. 310, are recorded. The verification module 50 is configured and operable for retrieving those handling conditions 311C to 313C from the handling conditions register 310C and to compare them with the respective authenticated execution parameters 411A to 413A obtained by the system 100 (e.g. recorder in the second distributed ledger 20 or determined by the object handling management module 30) in order to verify whether or not the handling conditions of respective object transaction 310 are fulfilled.

Alternatively, or additionally, permitted interested parties, e.g. Eᵢ, E_{f}, may by themselves access/request the authenticated execution parameters 411A to 413A recorded in the second distributed ledger 20 to verify whether or not the handling conditions of respective object transaction 310 are fulfilled.

Yet alternatively or additionally, the first distributed ledger 10 may be implemented as a smart contract ledger 10S, in which the authenticated execution parameters 411A to 413A are recorded, which may for example be able to gain access to the second ledger 20. The smart contract ledger 105 (e.g. a ledger on Ethereum blockchain) may for example include a smart contract 310S for execution of object transaction 310, whereby the handling conditions register 310C for this object transaction 310 may be in this case included in the smart contract 310S itself. In this case, the handling conditions 311C to 313C of the object transactions, e.g. 310, may be presented as records (e.g. scripts or computer executable codes) of the smart contract 310S whose respective executions in the first distributed ledger 10 cause retrieval/read of respective records of authenticated execution parameters 411A to 413A from the second ledger 20, comparison of each respective handling conditions 311C to 313C with the corresponding authenticated execution parameters 411A to 413A, and determination of whether the respective handling conditions 311C to 313C in the smart contract 310S are met. e.g. executable code/script corresponding-to/presenting a handling condition 311C in the smart contract 310S initiates reading of the respective authenticated execution parameter 411A from the second ledger 20, and processes the authenticated execution parameter 411A by code/script of the handling condition 311C to determine whether the authenticated execution parameter 411A meets the requirements of the handling condition 311C as designated by its respective script/code. By doing so, per each handling condition 311C to 313C in the smart contract 310S, the smart contract 310S of ledger 10 can utilize the second ledger 20 of the system 100 to automatically verify whether the conditions of the object transaction 310 are met/fulfilled with respect to the physical object(s), e.g. O1 and possibly also 02, that are the subjects of the object transaction 310.

Thus, smart contract 310S or a handling condition registry 310C, associated with the system, may include at least one predetermined condition, e.g. 311C to 313C for carrying out said handling operation(s), e.g. OP1 to OP3 of the object transaction 310 of the object O1. A predetermined condition 311C to 313C, for carrying out a handling operation may be indicative of a certain entity designated to be in possession of the object O1 for executing the respective handling operation OP1 to OP3. Optionally, the at least one predetermined condition e.g. 311C to 313C, designated in relation to respective handling operation OP1 to OP₃, may further include one or more of the following:
Environmental/ambient conditions (e.g. temperature, humidity, lighting conditions, pressure, and/or inertial conditions, required for implementing the handling operation. The monitoring of some of these conditions and/or their effects on the object O1, via XRF sensors/readers, is described for example in WO 2018/055625 co-assigned to the assignee of the present application and incorporated herein by reference.
Location conditions (e.g. allowed geographical coordinates/places) for implementing said handling operation;
Identification of another object, e.g. O2 which should be assembled with the object O1 under conditions of the object transaction 310. e.g. the identification may be via XRF marking of the another object O2, and via pairing of the another object with the object—as described for example in WO 2017/175219 co assigned to the assignee of the present application and incorporated herein by reference) as a pre-requisite for the handling operation.

Indeed, monitoring these conditions may be pertinent for handling operations such as transfer of possession of the object O1 between entities (e.g. OP1) and may also be required for other operations/or in operations associated with storage or transportation of the object O1 (e.g. OP2), and/or possibly also in assembly of the object O1 with another object O2.

In this connection, the object handling management module 30 may be connectable to one or more sensory systems (e.g. sensors), S1, S2, S3 (which may be included in, or associated with, respective readers R1, R2, R3). The sensory systems S1, S2, S3 are configured and operable for measuring execution conditions of said at least one predetermined condition 311C to 313C, in relation to the handling operations OP1 to OP3, and accordingly communicate these execution conditions with the parameters of execution 411M to 413M of the handling operation OP1 to OP3 to the object handling management module 30. Thus, the object handling management module 30 being connectable to reader unit(s), e.g. to R1, R2 and R3, is adapted for identification of the object O1 (by reading the specific marking M1 thereof the object O1), and the one or more sensory systems S1, S2, S3 are associated with the reader unit(s), R1, R2 and R3, and are adapted to communicate execution conditions of the respective handling operation, e.g. OP1 to OP3 (together with identification of the object O1 read by the reader unit).

In this connection, a reader unit e.g. R1, R2, R3, may include a suitable marking reader (e.g. XRF reader, QR-Code reader RFID reader and the line), an identification module memory carrying the identifier of the reader R1_{id}, and a readout utility for communicating the identifier of the reader R1_{id} and data O1_{id} indicative of the marking M1 that was read to the object handling management module 30. A sensory system (e.g. sensor) e.g. S1,S2, S3 may include at least one sensor, S1, S2, and/or S3 described above and a readout utility for communicating parameters of execution data measured by the sensor to the object handling management module 30. The at least one sensor, S1, S2, and/or S3 may include at least one of the following: temperature sensor, humidity sensor, light sensor, position sensor (e.g. GPS), and inertial sensor. In some embodiments the reader unit and the sensor system are combined in one system/module capable of both reading the markings of the objects, as well as sensing additional execution parameters, as described above.

Reference is made now to FIG. 2C, which is a block diagram of system 100 according to an embodiment of the present invention configured as an independent, integral (self-standing), object signature reader system (e.g. referred to above also as reader or reader unit). The object signature reader system 100 in this example is configured and operable for operating independently for monitoring/measuring handling operations of an object; authenticating the handling operations, and possibly verifying that the authenticating handling operations meet predetermined conditions, and registering the authenticated and possibly also verified handling operations in the second ledger 20. The object signature reader may be in data communication with a blockchain network 501 including one or more blockchain systems 500 and optionally digital wallets DWs and may thereby enable the validation of the object transactions in the first distributed ledger 10 implemented by the one or more blockchain systems 500. In this regards, it should be noted, that the object signature reader system 100 may be configured and operable to communication with the blockchain systems 500 for validating handling operations and/or object transactions via direct communication with nodes/servers of the blockchain systems 500 (not specifically illustrated in this figure), or via indirect communication with the digital wallets DWs which in turn communicate with the nodes/servers of the blockchain systems 500.

The object signature reader 100 integrally includes (e.g. in one apparatus):

(a) a signature/marking reading module R configured and operable for reading a marking/signature on the physical object O1 to determine data of indicative of the marking/signature;

(b) an identifying module 90 (e.g. an internal memory/storage module) carrying reader ID data that uniquely identifies the object signature reader 100;

(c) a network communication module 70 configured and operable for providing data communication of the object signature reader 100 to access reference data 60. The reference data being indicative of markings/signatures of one or more physical objects, e.g. O1, and the specific entity in possession of the object signature reader 100 in association with the reader ID data. The network communication module 70 is also configured and operable for providing data communication between the object signature reader 100 and the blockchain network 501, e.g. the one or more blockchain systems 500 or the digital wallets DWs associated therewith; and

(d) an object handling management module 30 connected to the signature/marking reading module R and to the communication module 70. The object handling management module 30 which may be configured/operable similarly as described above for authenticating execution parameters of at least one handling operation carried out with respect to the physical object O1 by carrying out the following:
authenticating the identity or type or batch of the physical object O1 by determining a match between: data of the marking/signature of the physical object O1 obtained from the reading module R with the markings/signatures of the one or more physical objects stored by the reference data 60;
authenticate identity of the entity in possession of the object signature reader 100 by determining a match between the reader ID data 90 identifying said object signature reader 100, and identity of that entity listed in the reference data 60.
   Accordingly the object handling management module 30 authenticates the handling operation.

The object handling management module 30 may also be configured and operable to operate the network communication module 70 to access the one or more blockchain systems 500 (e.g. via the blockchain network 501) and validate registration of the authenticated handling operation in the second distributed ledger 20. Accordingly, the object signature reader 100 enables recordation of an object transaction associated with the physical object O1 in the first ledger 10 upon validation of authenticated of handling operations associated with that object transaction in the second ledger 20.

Optimally, the object handling management module 30 is adapted to authorizes the reading module R to read the marking/signature of the physical object O1. Such authorization may be implemented as described above, by providing the reading module R1 with data indicative of reading parameters by which to read the marking/signature of the specific object O1. In turn, the reading module may be adapted to operate a certain reading scheme corresponding to the reading parameters and thereby determine the data of indicative of the marking/signature of the specific object O1.

Optionally, the object signature reader 100 also includes the condition verifier module 50 , which may be adapted, as described above, to obtain data indicative of predetermined conditions of the handling operation and enable validation of registration of the authenticated handling operation in the second distributed ledger only upon verifying that the execution parameters of the authenticated handling operation comply with the predetermined conditions.

Optionally, the object signature reader 100 also includes the token management module 40 as describe above, which may be connectable to the object handling management module 30, or to the network communication module 70, and configured and operable to enable authentication/validation of the handling operation upon at least one predetermined token transaction in the one or more blockchain systems.

Optionally the object signature reader 100 is configured and operable for reading/recognizing elemental XRF signature embedded with the physical object O1. In such embodiments the reading module may include an XRF measurement module (not specifically shown) configured and operable for carrying out XRF measurement of the physical object to read the XRF signature/marking (e.g. by illuminating at least part of said object with X-Rays or gamma-Rays and detecting X-Ray-Fluorescence response indicative of said XRF signature/marking, and optionally performing spectroscopic analysis on the response).

In some cases the object signature reader 100 also includes one or more sensors S configured and operable for measuring one or more execution conditions (e.g. environmental/ambient conditions, location, timing and or inertial conditions as described above, which are present at the time the handling operation is performed. These may be registered in the second ledger 20 (e.g. by the object handling management module 30) in association with the authenticated handling operation, and may be used to verify that the handling operations meets the predetermined conditions of the object transaction in the first ledger 10.

It should be noted that optionally, at least part of the reference data 60, or all the reference data 60 used by the object signature reader 100 for authenticating handling operations, is stored in decentralized distributed manner by the one or more blockchain systems 500. To this end, the object handling management module 30 may be adapted to access the one or more blockchain systems 500 directly or indirectly, for retrieving at least the required parts of the reference data 60 which are needed for authentication the handling operation of an object.

To this end, configuration of the system 100 as independent/integral object signature reader 100 (which is not associated with any centralized service/server or module, and/or the storage (system) of the reference data 60 used for the authentication of the handling operation in decentralized distributed manner in a blockchain, and the use of elemental marking/signatures inseparable from the physical object O1, provide together a robust handling operations authentication technique which cannot be practically forgeable or counterfeited. Moreover the registration of the authenticated handling operations in a second distributed ledger 20, while on the one hand may enable any interested party, e.g. digital-wallet or entity, to access the authenticated data if handling operations associated with object transactions, one the other hand cannot be practically counterfeited, thus facilitating a robust way to verify occurrence of authenticated handling operation which are required for registration of an object transaction pertaining to physical objects.

Thus the system 100 of FIG. 2C may be provided to various independent entities along a supply chain who can use such system independently from one another or from any centralized system/entity for authenticating handling operations performed thereby on physical objects and recoding the same in a distributed ledger 20.

It should be understood that further details and implementations of the system 100 of FIG. 2C may be similar to the those described with reference to System 100 of FIG. 2A above, optionally with proper modifications for making such system integral, as would be appreciated by those versed in the art.

Another embodiment of the system of the present invention is shown in FIG. 3 which is a schematic illustration of the general structure of the system 100 according to certain embodiments of the present invention for implementing smart contracts. Like reference numerals are used in all the figures of the present application to designate similar element modules, or systems or modules, or systems having similar functions in different embodiments of the present invention.

The system 100 of FIG. 3 includes a management system 30 which may be similar to the management system of FIGS. 1 and 2A, an optional token management tool 40 and a plurality of blockchain systems BC1, BC2, to BCn. The management system 30 communicates with a plurality of reader units R1, R2 to Rn which are similar to readers R1 to Rn of FIG. 1 or 2A. Each of the blockchain systems BC1 to BCn interacts with a plurality of digital wallets (not specifically shown in FIG. 3) which may be similar to digital wallets DW1, DW2, to DWn described above with reference to FIGS. 1 and 2A. The token management tool 40 interacts with blockchain systems BC1 to BCn, namely the token management system may enable to access the data stored by the management system and/or services provided by the management system 30 (e.g. which are needed for reading the marking of marked objects). Some or all of the blockchains systems BC1 to BCn may also implement a first ledger (e.g. referred to above as 10) and manage records of ownership and transactions of corresponding native tokens/currencies (that is each a blockchain with its native token). Access to the management system 30 may be granted upon the execution of transactions in these native tokens. For example, the token management tool 40 may allow access in response to payment which may be carried out in any one of the of these native tokens (made to preselected digital wallets associated with each blockchain). One or more of the blockchain systems BC1 to BCn may also manage records and transactions involving marked objects (in addition to its native token).

The system 100 of the present invention may implement various types of smart contracts, which may or may not involve marked objects. For example, the system of the present invention may be implemented by platforms such as the Ethereum blockchain which provides general scripting language. In addition, by using the token management tool, the present invention enables the implementation of smart contracts, which involve marked objects or include extraction of data from the management system.

A first type of operation is the registration/creation of a record of the marked object on the blockchain system, that is the marked object is recorded as belonging to a certain party (a digital wallet) identified for example by a public key. This type of operation may be conditioned on the transfer of an amount of tokens (that is, the operation requires payment in tokens).

A type of smart contract which may be implemented by system 100 of the present invention is a change in ownership of a marked object, which is conditioned on verification that the marked object is marked by a particular signature or code. For instance, the party receiving the ownership may wish to verify that the object is authentic by checking whether the object carries a specific marking (for example such a marking may be applied to the object during manufacturing).

In an example, the reading of the signature on the object is carried out in an initial stage wherein the smart contract is executed only if the correct signature is identified. Alternatively, the signature may be read only at the final stage of the transaction, wherein the party receiving the ownership verifies that the object is authentic. In yet another example, the signature on the object is read more than once, for example both at an initial stage wherein the retrieving the correct signature is a condition for executing the next steps of the smart contract, and the at the final stage to finalize the transaction.

Reference in now made to FIG. 4 which is a schematic illustration of a system 100 for implementing a smart contract according to the present invention.

Creating a new record of a marked object—Party E which owns an object (for example, the manufacturer of an object) may wish to mark the object and create a record of the object in the system, namely a record corresponding to the marking in the management system, and a record of its ownership in the blockchain system. Party E has a digital wallet DWᵢ on which data corresponding to the object is stored including data (such as private keys) enabling party E to prove his ownership of the object. In addition, DWᵢ may also store data associated with tokens, in particular data proving party E owns an amount of tokens. DWᵢ communicates with the blockchain system 500. The object is recorded in the system 100 by marking it and reading the marking using a registered reader, that is, a reader whose ID is registered by the management system 30. The reader communicates with the management system 40 for receiving permission to carry out reading the object and transmitting data corresponding to the marking to the management system 30. The management system 30 communicates with the blockchain system 500 for transmitting thereto data corresponding to the marking on the objects, and optionally additional data. For example, the additional data may relate to the type of the marked object, data indicative of the time and/or location of the reading, data identifying party E and/or the specific reader used to read the marking, and so on. Optionally, the registration of an object in the blockchain system 500 may be conditioned by the transmission of information, from the reader to the blockchain system 500, to provide data relating to the reading of the object of the marked object (for instance the time and place of the reading, data identifying the party operating the reader or the owner of the marked object, and so on). In addition, registration of a record of a marked object on the blockchain system may be a prerequisite/condition for the transfer of an amount of tokens to for example the party Eᵢ) a preselected digital wallet/account may be verified by the token management tool (e.g. tokens may be transferred to a digital wallet on the condition that object was registered).

In transfer of ownership of a marked object, the ownership may be transferred by party Eᵢ, by using its digital wallet DWᵢ to proving its ownership of the object and providing instruction to transfer the ownership to party E_{f} who uses digital wallet DW_{f} (for example a distributor or a client). Such a transaction may be finalized only by party E_{f} (or its representative), by reading the marking on the object by a reader associated with the management system 30, communicating data indicative of the read marking to the management system 30, and authenticating the marking on the object by the management system 30. The communication may include several other steps such as receiving permission to carry out the reading and/or receiving data which is required for the reading.

In another example, the transfer of ownership may be carried out by reading the marking on the object while it is held by party Eᵢ before it is handed to party E_{f}. In a further example, the transaction of transferring the ownership of the marked object requires reading the marking before it is handed to party E_{f} (by party Eᵢ) and by party E_{f} after receiving the marked object.

In an aspect of the invention the management system 30 communicates with the blockchain system 500 only at the initial stage for the purpose of verifying that the object to be registered in the blockchain system is marked and registered in the management system 30. Once the management system confirms to the blockchain system 500 that the object is marked and registered, any additional data from the management system 30 may be transferred via the digital wallets. For example, once the management system 30 confirms to the blockchain system 500 that an object is marked and registered, it may generate a public key, or set of keys (using public key encryption and/or digital signature schemes), associated with the marked object, such that the management system 30 may transmit, via the digital wallet, data (e.g. a digital signature associated with the object) that confirms that the transaction that the digital wallet is implementing relates to a registered marked object, and that, in the case where the transaction requires a reading, the marking was read and authenticated by the management system 30.

The blockchain system 500 may include records of ownership and transactions in two different types of objects: marked object and tokens. This allows the implementation of smart contracts where transactions and procedures involving a first type of assent are conditioned on a transaction involving another. For example, a transfer of ownership of a marked object (from party Eᵢ to party E_{f}) may be executed only upon executing a parallel transaction of transferring a preselected amount of tokens from party E_{f} to party E. Namely, the first transaction (transferring ownership of the object) is conditioned on the second transaction (transferring tokens). Alternatively, one can reverse the conditioning. That is, the second transaction can be made to depend on the execution of the first. In a third example, both transactions may be executed and finalized jointly. Namely, none of the transactions is executed without the execution of the other.

Such conditional transactions can be implemented by allowing nodes in the blockchain system to include a first transaction block, only if a previously executed second transaction, which is indicated to be a condition in the first transaction, is found in the chains of blocks of transactions. Accordingly, nodes operating to validate transactions, would validate the second transaction only upon verifying the presence of the second transaction in the chain of blocks.

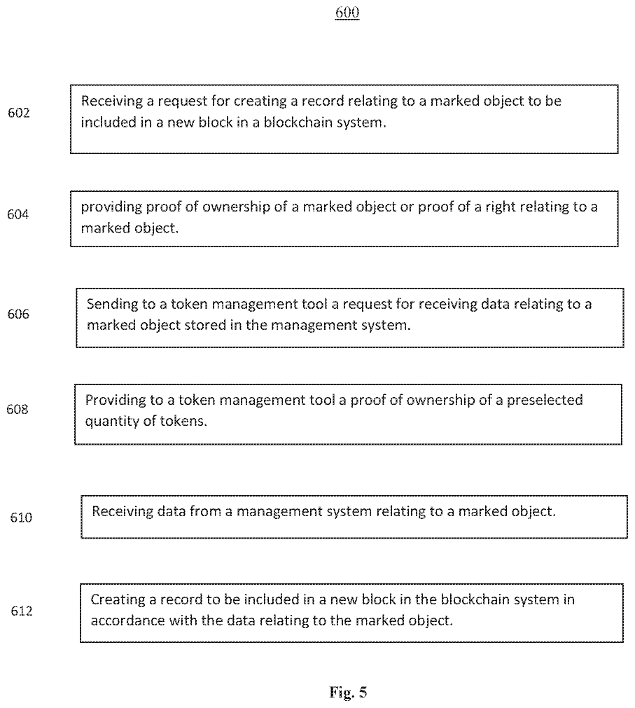

Reference in now made to FIG. 5, which is a flow chart of a method 600 according to an embodiment of the present invention for implementing a smart contract for transferring ownership of a marked object wherein the transferring of ownership is conditioned on the receiving information relating to the marked object from the management system 30.

In step 602 the blockchain system 500 receives a request from a digital wallet representing one party (party Eᵢ) to initiate a smart contract in which the ownership of a marked object will be transferred from party Eᵢ to party E_{f} (i.e. to record the transfer in ownership in a new block to be included in the blockchain 500) conditioned on reading a signature which is present on the object (thus verifying its authenticity).

In step 604 the digital wallet of party Eᵢ proves its ownership of the marked object by communicating with the blockchain system 500 and providing required data, for example data which demonstrates to the blockchain system that party Eᵢ keeps a private key in public key cryptographic protocol.

In step 606 one of the parties to the smart contract (either party Eᵢ or party E_{f}) sends a request to the token management tool 40 to access specific information managed by the management system 30 relating to the marked object. For example, such information may be data which is indicative of the signature on the object (for instance a hash of the signature). In another example, the information may be the signature on the object as read by a reading unit; in yet another example the information may be just a confirmation that a signature read by a reading unit is identical to the signature stored by the management system 30.

In step 608 one or both parties provide to the token management tool 40 proof that they own a preselected amount of tokens which is the amount required for providing the information requested in step 606. The amount of tokens is the authorization or payment for providing the requested data from the management system 30.

In step 610 the requested data is received from the management system.

In step 612 the blockchain system 500 creates a record of the transfer of ownership from party Eᵢ to party E_{f} in a new block of data within the blockchain 500 system 500 in accordance with the data received from the management system 30. For example, the new record may be created only upon receiving confirmation from the management system 30 that the signature on the marked object read by a reading unit is identical to the corresponding signature stored by the management system 30.

According to some embodiments, the system 100 of the present invention is configured and operable for managing and supervising of chain-of-supply of various products and commodities (hereinafter also referred to as object(s)). For example, an object going through a supply chain may be marked and recorded in the blockchain system 500. The blockchain record may specify the party which, at a given time, is in possession of the object. As the object progresses through the supply chain, changing hands, additional records are added to the blockchain 500 such that the chain of possession (that is the list of all parties which had possession of the object) is recorded on the blockchain from the manufacturer to its final destination (e.g. an end customer, a distributer, another manufacturer).

The party in possession of the object may be different than the party which owns the object. For example, a product or a component may be bought by a party even before it is manufactured, such that already at the factory, the object is owned not by the manufacturer, but by a client. In an aspect of the present invention, the blockchain keeps a record of both the party in possession of the object, and the party which owns the object. To this end, the blockchain system(s) 500 described herein may be considered to be more than one ledger, e.g. one for recording object's ownerships, and another for recording the changes in the entities having actual possession of the object, and optionally additional ledgers, e.g. a ledger indicative of the markings on objects, or a ledger indicative of the entities having a reader unit of the present invention in their possession and the identification of the respective reader units.

Updating or changing the above two types of records (i.e. changing ownership and changing record of possession) may require confirmation or data from the management system 30 and/or use of a reader in order to read and validate the marking on the object. The token management tool 40 may distinguish between these types of record updates (transactions) by requiring different authorizations/payments in tokens for the different transactions. For example, the token management tool 40 may allow access to the management system 30 (and the readers) for change of ownership purposes only upon the existence of a parallel transaction of transfer of tokens (i.e. payment in tokens), while allowing access to the management system 30 for the purpose of changing records of possession.

Supply chain management systems may utilize or include a system of sensors (attached for example to products or packages) which monitor environmental conditions (e.g. temperature, humidity, etc.) and/or the condition of the objects which progress along the supply chain (for instance during shipping). Data acquired by sensors may be recorded in the blockchain systems 500, providing an immutable log of the sensor data. The sensor data recorded on the blockchain 500 may be open to all (or at least to all the certified parties in the case of a permissioned blockchain) such that, for example, the party E_{f} receiving the object or product may verify that environmental conditions did not exceed a permitted range during the preselected time (e.g. during shipment). In addition, a blockchain system 500 for sensor data enables the implementation of smart contracts which involve data acquired by sensors relating to object during the preselected time period. For example, a transaction in which ownership is transferred from one party to another may only be executed if no deviation in the environmental conditions was recorded (e.g. a food or pharmaceutical product was continuously kept at a proper temperature).

The system 100, according to some embodiments of the present invention, may provide an additional layer of safety and reliability to such a scheme by enabling the relevant parties, e.g. Eᵢ, E_{f} and any intervening party/entity along the supply chain, to verify that sensor data uploaded to the blockchain for a product or package does belong to the correct product. Namely, creating a one-to-one correspondence between a sensor (and sensor data) to an object (e.g. a product, a package or a container) by reading the marking on the object, which should correspond to an ID of the sensor. For example, the data stored on the sensor may include an ID number which corresponds to the signature provided by the marking on the system. The ID numbers of the sensors and the correspondence between the sensors and the object signature may be stored in the management system 30. Alternatively or additionally, the sensors themselves may be marked by the marking which can be read and identified by a reader.

The system 100, according to some embodiments of the present invention, may enable sensor data to be recorded on the blockchain only upon reading of the marking on the object and obtaining a ‘correct’ result. Additionally, the system of the present invention may implement a smart contract wherein a change in ownership of a marked object or a change in possession is recorded only upon verification that recorded sensor data did not include deviations from a preselected range, and that the sensor does correspond to the object to which it is attached.

In another aspect, the present invention provides a system for implementing smart contracts wherein the chain of possession, and optionally additional terms and conditions, are set by a privileged party. In an example, the privileged party is the owner of object or a product. In other examples, the privileged party may be the manufacturer of an object, or a privileged party within a blockchain system, for instance an authorized party in a permissioned blockchain. The parties in possession of the object along the chain of possession, for example, may be various entities taking part in a chain of supply of a product such as a manufacturer, a delivery company, a shipping company, a distributor, and an end client or an owner, or future owner, of a product. The manufacturer of the product, (or alternatively, the owner) may initiate a smart contract wherein the chain of supply from the manufacturer to an end client or a group of clients (e.g. clients from the same area) is set by the manufacturer.

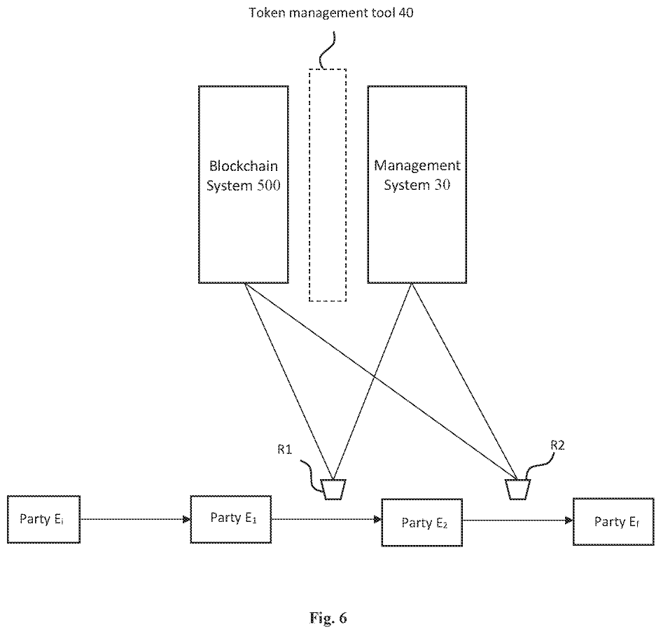

Reference in now made to FIG. 6 which is a schematic illustration of an embodiment of a system 100 for implementing a smart contract and managing supply chains according to an embodiment of the present invention. The system 100 includes or is associated with a blockchain system 500, and includes a management system 30, and optionally a token management tool 40. Additionally, the system 100 may include a plurality of readers, e.g. R1 and R2, as exemplified in FIG. 6. The readers communicate with the management system 30 and the blockchain system 500. FIG. 6 also illustrates a plurality of parties Eᵢ, E₁, E₂ and E_{f} which communicate with the blockchain system 500 and the management system 30 and furthermore carry out transactions and implement smart contracts on the blockchain system 500, via digital wallets or system applications (not specifically shown in FIG. 6). System 100 enables the plurality of parties to implement smart contracts relating to the marked physical assets/object recorded by the management system 40 (e.g. on the blockchain system 500), whereby the smart contracts may also involve virtual assets) such as a native token or cryptocurrencies. Party Eᵢ, for example, may wish to transfer the object to party E_{f} the final holder, which will be in possession of the object, via parties E₁ and E₂. In a particular example, party Eᵢ may be the manufacturer or the initial owner of the object, Party E_{f} the final owner of the object (say a client which buys the object) whereas Party E₁ may be the shipment or a delivery company, and party E₂ may be a distributor. In another example, party Eᵢ may be an owner of a work of art who wishes to transfer it to another entity E_{f} (say a museum or a gallery) for exhibition. Party Eᵢ may initiate a smart contract in which the chain of possession of the object is set according to his demands Namely, party Eᵢ may allow the object to be delivered only by a particular delivery and/or shipping company, or a group of authorized companies. Furthermore, party Eᵢ may condition some or all changes of possession in the supply chain in reading the marking on the object, thereby proving, at any transfer of possession that includes a reader, that the authorized party was given the object. With reference to FIG. 6, the smart contract sets the chain of possession and in addition conditions the change of possession from party E₁ to party E₂ and from E₂ to party E_{f} by a reading of the marking of the object (by readers R1 and R2 respectively), whereas in this example the transfer of possession from party Eᵢ to party E₁ had not required a reading of the marking The record of transactions wherein the possession of the object is changed, is stored on the blockchain 500 (e.g. in second ledger 20 described above), as well as the record of ownership (e.g. which may be stored in the first ledger 10 described above). The smart contract may also involve a change in ownership of the object which may or may not be conditioned on a reading of the marking

Party E₁ (or any other party which owns an object) may implement smart contracts which may be conditioned on a variety of factors (in addition to reading of the marking on the object). A transfer of possession (or ownership) may be conditioned on: the time and and/or location of the reading (verified for instance by using a GPS), the specific reader and the person/company operating the reader which may be verified by ID of the reader which may be transmitted to the management system or to the blockchain system (e.g. via the digital wallet or the system application), and the person operating the reader. In another aspect of the system 100, in a case where the objects are marked by two different types of markings, each providing different levels of validity, party E₁ may initiate a smart contract which includes a chain of possession transfers between a number of parties, wherein some possession transfers require one type of reader, and other possession transfers require the use of another type of reader (providing a different level of security, validity or authenticity). In an example, the object may be marked by an XRF-sensitive marking and a barcode or QR-code. The smart contract may require reading of the XRF marking, which provides high level security and authenticity (and may require data from the management system 30) at some possession transfers, and a reading of the barcode, QR-code at other possession transfers.

As mentioned above, the system 100 may also utilize various types of sensors for various purposes, such as keeping track and recording environmental conditions along the supply chain. A smart contract may also be conditioned on the data recorded by the sensors. Blockchain system 500 may deny a change in the ownership or possession of the object if the conditions and terms of the smart contract are not met. Alternatively, the blockchain system 500 may record the change in ownership or possession and record it as an unauthorized change. In a different example, the blockchain may extract a fine or a fee paid in a native token of the blockchain system 500 from an account or a digital wallet associated with the party or parties which failed to meet the terms of the smart contract to a preselected digital wallet (e.g. a digital wallet of the owner or the party which initiated the smart contract).

In another aspect, the system 100 according to the present invention allows the marking of both an object or a product and its components and sub-components and recording the chains of possession of the components and sub-components which combine into a single object/product. That is, the blockchain 500 may record a ‘tree’ of possession of components and subcomponents (and possibly the end product) representing a plurality of chains of possessions. This is illustrated for instance by operation OP3 in FIG. 2A described above, in which a first O1 object and a second object O2 are assembled together, whereby optionally the markings on both objects may be read and authenticated in other to validate the handling operation. This results de-facto in a tree being recorded in the blockchain 500 which represents the chain of positions of the plurality of objects, from their origination (initial respective entities Eᵢ's, until they arrive (e.g. are assembled together) to the final/recipient entity E_{f}.

Thus, a component that is received by a manufacturer (of the end product or one of its components) may use the components on condition that it is marked and that the marking is read and recorded on the blockchain. This scheme of marking components and recording them on the blockchain system provides assurance that the components, (or some of them), which are marked, are the ‘correct’ ones. Moreover, the manufacturer of an end product can be assured not only that the components he receives are authentic, but that its sub-components (all the way back to basic components) are authentic and originate from the correct source.

According to some embodiments of the present invention, the system 100 may be configured and operable for enabling offline authentication of the objects and their handling transactions, by creating correspondence between an ID (e.g. a product or a serial number) and an XRF marking applied to an object or a product. In this connection, the term offline authentication should be understood as authentication that does not require a priori stored reference data indicative of a correspondence between a marking which marks objects, and the respective identification of the object (e.g. which does not necessarily require access to the Obj′-Data reference described with reference to FIG. 2A above). Accordingly, as there may not be a need to access the reference data, the authentication of an handling operation may be performed off-line. This is achieved by marking an object with a mark whose signature corresponds to (e.g. is indicative of) the ID of the object or batch which is to be identified (e.g. signature corresponding to the a product ID or a serial number of the specific product). Thus, the ID may correspond to a single object, or to a batch of objects. The ID may be an overt marking applied to the object during or after manufacturing, such as ID an identifying product or serial number. The ID can be a machine readable marking such a bar code or a QR code. In a further example, the ID can be covert, that is identifiable with suitable means or under suitable conditions. The XRF marking is applied to the object in correspondence to the ID. Namely, the materials and elements included in marking are according to a coding system, translating the amount and/or concentrations of marking materials, and possibly additional factors affecting XRF response spectrums (e.g. material present in the object, measurement conditions including the energy of the primary radiation exciting the response signal, and the source-object-detector geometry) into a code (e.g. binary code) which represents a signature of the ID of the object. The signature is a function of the ID for example, a hash function or a cryptographic hash function of the ID. The XRF marking may be prepared by a dosing machine. The XRF marking may be applied to the object by various techniques including printing, stamping, spraying, injecting, brushing, and airbrushing.

The XRF marking may be applied or disposed onto the object with a marking device of type described in International Patent application publication No. PCT/IL2018/050527 which is incorporated herein by reference.

The correspondence between the ID and the XRF marking may add an additional authentication and anti-counterfeit layer, since any change or tampering attempt with the ID of the object can be detected by reading the XRF marking on the object.

Furthermore, the correspondence may be employed in a supply chain management scheme (such as in the scheme of the embodiment of FIG. 6) as it allows for offline authentication. For example, system 100 may implement a smart contract wherein the chain of possession is set by a party initiating the smart contract. A transfer of possession between two parties under the condition that the marking be read before the transfer of possession takes place, may be carried out offline. That is, the marking is read in situations where there is no connection between the reader to the blockchain system 500 and/or to the management system 30, yet the transfer is recorded in the blockchain system once a connection is established, on condition that the XRF marking was read and found to correspond to the ID on the object. This type of offline authentication may require authorization from the token management system 40.

1. A system for managing transactions of physical objects, wherein:
the system is connectable to a first distributed ledger adapted to record object transactions associated with transactions of one or more physical objects between parties;
the system comprising:
a second distributed ledger adapted to record data indicative of object handling operations carried out with respect to the one or more physical objects; and
an object handling management module adapted to authenticate handling operations carried out with respect to the one or more physical objects by carrying out the following: obtaining parameters of execution of said handling operations, authenticating said parameters of execution, and recording said parameters of execution of said handling operations in the second distributed ledger;
thereby enabling recordation of the object transactions associated with said one or more physical objects upon authenticating that the parameters of execution of the handling operations that are carried out with respect to the one or more physical objects satisfy one or more respective predetermined conditions.

2. The system of claim 1 wherein said first ledger is configured and operable for recording at least one of the following:
i. transactions of ownerships of said one or more objects; and
ii. transactions of tokens associated with changes of ownerships of said one or more objects.

3. The system of claim 1 wherein the first distributed ledger is a smart contract ledger having access to said second distributed ledger and adapted to obtain said data indicative of at least one handling operation carried out with respect to a certain physical object and recording transaction of said at least one object in the first ledger upon determining that said at least one handling operation complies with at least one predetermined condition indicated by a smart contract in the smart contract ledger for transaction of said at least one object.

4. The system of claim 1 comprising a Condition Verifier Module, having access to said second distributed ledger and adapted to obtain said data indicative of at least one handling operation carried out with respect to a certain physical object; and recording transaction of said at least one object in the first ledger 10 upon determining that said at least one handling operation complies with at least one predetermined condition.

5. The system claim 1 connectable to at least one blockchain system configured and operable for implementing at least one of said first and second distributed ledgers.

6-7. (canceled)

8. The system of claim 1 connectable to a blockchain system configured and operable for irripiementing said second distributed ledger; and wherein the object handling management module includes privileged nodes of said blockchain system operable for recording, in the second distributed ledger, the parameters of execution of the handling operations; and wherein non-privileged nodes of said blockchain system, are not allowed to initiate writing of data records of the second distributed ledger in the blockchain.

9. (canceled)

10. The system of claim 1 comprising a token management module connectable to said object handling management module, or to a communication module of the system, and configured and operable to enable authentication/validation of said handling operations by said object handling management module upon receipt of data indicative of at least one predetermined token transaction in a certain blockchain system.

11. (canceled)

12. The system of claim 1 wherein the object handling management module is adapted to authenticate the handling operations, carried out with respect to said one or more physical objects, being marked by one or more markings readable by one or more reader units;
whereby the object handling management module is connectable to at least one of said reader unit adapted for identification of an object of said objects by reading a specific marking of the object, and the object handling management module is connectable to one or more sensory systems, which are associated with said at least one reader unit, and adapted to measure the parameters of execution of the handling operation carried out on said object; the object handling management is adapted by to obtaining the identification of said object from said reader unit, and the parameters of execution of said handling operation from said one or more sensory systems, and verify that said parameters of execution of the handling operation carried out on the identified object, satisfy said one or more predetermined conditions.

13. The system of claim 12 wherein the object handling management module is adapted to obtain data identifying said reader unit and authenticate said handling operation of the object by:
utilizing said specific marking of the object to authenticate identity of said object,
utilizing the data identifying said reader unit to authenticate identity of an entity which has possession of the reader unit and which implements said handling operation,
thereby verifying that said handling operation is carried out on the identified object by said entity; and
wherein the system is adapted for carrying out at least one of the following:
i. authenticating the identity of said object by determining a match between: data of said specific marking of the object as obtained from said reader unit, with pre-stored reference data indicative of said specific marking by the object,
ii. authenticate identity of the entity in possession of the reader unit by determining a match between the data identifying said reader unit, and reference data listing identities of said one or more reader units in association with respective entities that are in possession of said one or more reader units
iii. authenticating said handling operation comprises verifying that said handling operation, which is carried out on said object, is authorized for said entity.

14-16. (canceled)

17. The system of claim 12 wherein the object handling management module is adapted to authorize said reader unit to read said specific marking of the object; and wherein the object handling management module authorizes said reader unit to read said specific marking, by communicating the reader unit with data indicative of reading parameters by which to read said specific marking; whereby said reader unit is adapted to operate a certain reading scheme corresponding to said reading parameters and thereby determine and communicate said data indicative of a specific marking of the object, to said object handling management module.

18-19. (canceled)

20. The system of claim 12 wherein the physical objects are marked by physical markings indicative of said physical objects and are applied to, or embedded within, said physical objects; and wherein at least one of the following:
the physical markings of respective physical objects identify said respective physical objects:
the physical markings identify the types or batches of the respective physical objects.

21. (canceled)

23. The system according to claim 20 wherein the physical markings are X-Ray-Fluorescence (XRF) signatures identifiable via XRF analysis of the respective physical objects, and wherein said reader units are configured and operable for carrying out XRF measurements to read said XRF signatures; and whereby said reader units are configured and operable to carry out said XRF measurements by illuminating at least parts of said objects with X-Rays of gamma-Rays and detecting X-Ray-Fluorescence response indicative of the XRF signatures of said objects.

24-26. (canceled)

27. The system of claim 1 wherein said handling operation may include any one of the following:
(i) change in possession of the object;
(ii) transportation/Storage of the object;
(iii) assembly of the object with another object.

28. The system of claim 1 being associated with a smartcontract or a handling condition registry including at least one predetermined condition for carrying out said handling operations of the transaction of the object.

29. The system of claim 12 wherein said at least one predetermined condition for carrying out said handling operation includes:
at least data indicative of a certain entity designated to be in possession of said object for executing the respective handling operation
one or more of the following execution conditions:
environmental/ambient conditions required for implementing said handling operation,
location conditions for implementing said handling operation,
identification of said another object as a pre-requisite for the handling operation.

30-34. (canceled)

35. A method for managing transactions of physical objects comprising carrying out the following per each handling operation of one or more handling operations, which are to be performed with respect to an object, for registration of an object transaction for said object in a first distributed ledger:
determining measured execution parameters of said handling operation, whereby determining the measured execution para e s comprising reading a marking/signature of the object by a reader assigned to an entity performing the handling operation;
authenticating the measured execution parameters, to determine data indicative of said object on which said handling operation is performed based on said marking/signature read by said reader, arrd identify said entity performing the handling operation based on data about said reader; and
utilize the authenticated execution parameters to validate registration of the handling operation in a second distributed ledger, presenting a distributed ledger of authenticated handling operation;
thereby enabling to validate registration of said object transaction in the first distributed ledger, upon registration of each of said one or more handling operations as authenticated handling operation in said second ledger.

36. (canceled)

37. The method of claim 35 wherein said determining of the measured execution parameters of at least one handling operation further comprises measuring additional sensory data from a sensor associated with said. reader; and said vent ring further comprises determining a match between said sensory data and additional execution conditions included by said predetermined conditions; and wherein validation of said registration of the handling operation in the second ledger comprises said verifying of the measured execution parameters of the handling operation.

38-39. (canceled)

40. The method of claim 35 herein said first ledger is a smart contract ledger comprising a smart contract of performing said object transaction; said smart contract mprises sub-transactions whereby one or more of said sub-transactions are associated with said one or more handling operations and are adapted for accessing said second ledger and carry out said verifying that the authenticated execution parameters of the one or more handling operation fulfill the predetermined conditions required for said object transaction.

41. (canceled)

42. The method according to claim 35 wherein said object has identifiable XRF signature/marking and said reading includes detecting the XRF signatures of said object to thereby enable determination of identity or type or batch of said object.

43. (canceled)

44. An object signature reader in data communication with one or more blockchain systems for validating object transactions in a first distributed ledger of the one or more blockchain systems, said object signature reader comprising:
a signature/marking reading module configured and operable for reading a marking/signature on a physical object to determine data of indicative of said marking;
an identifying module carrying reader ID data uniquely identifying said object signature reader;
a network communication module enabling data communication of said object signature eader to access reference data indicative of markings/signatures of one or more physical objects and an entity in possession of said object signature reader associated with said reader ID data, and enabling cornrnunication of said object signature reader with the one or more blockchain systems;
an object handling management module connectable to said signature/marking reading module and to said communication module and configured and operable for:
(i) authenticating execution parameters of at least one handling operation carried out with respect to said physical object by carrying out the following:
authenticating the identity or type or batch of said object physical object by determining a match between: data of said marking/signature of the physical object obtained from said reading module with the markings/signatures of the one or more physical objects in said reference data;
authenticate identity of the entity in possession of the object signature reader by determining a match between the reader ID data identifying said object signature reader, and identity of said entity listed in the reference data;
thereby authenticating said handling operation; and
(ii) operate said network communication module to access said one or more blockchain systems and validate registration of the authenticated handling operation iri a second distributed ledger in said one or more blockchain systems.
thereby enabling recordation of an object transaction associated with said physical object in the first ledger upon validation of authenticated of handling operations associated with said object transaction in said second ledger.

45. The object signature reader of claim 44 wherein the object handling management module is configured and operable to authorizes said reading module to read said marking/signature of the physical object, by providing the rendering module unit with data indicative of reading parameters by which to read said marking/signature; and wherein the reader module is adapted to operate a certain reading scheme corresponding to said reading parameters and thereby determine said data of indicative of said marking.

46. The object signatureea reader of claim 44 comprising at least one of the following:
a condition verifier module, adapted to obtain said data indicative of predetermined conditions of said handling operation and enabling to validate said registration of the authenticated handling operation in the second distributed ledger upon verifying that the execution parameters of said authenticated handling operation comply with said predetermined conditions;
a token management module connectable to said object handling management module, or said network communication module and configured and operable to enable authentication/validation of said handling operation upon at least one predetermined token transaction in said one or more blockchain systems.

47. (canceled)

48. The object signature reader of claim 44 wherein signature/marking of the physical object is an elemental XRF signature embedded with said physical object;
wherein said reading module comprises an XRF measurement module configured and operable for carrying out XRF measurement of said physical object to read said XRF signature/marking; and
wherein said reading module is configured and operable to carry out said XRF measurement by illuminating at least part of said object with X-Rays or gamma-Rays and detecting X-Ray-Fluorescence response indicative of said XRF signature/marking.

49. (canceled)

50. The object signature reader of claim 44 comprising one or more sensors configured and operable for measuring one or more execution conditions present at the time the at least one handling is performed, to thereby enable verification that the handling operation is performed under allowable execution conditions.

51. (canceled)
